(19) United States
(12) Patent Application Publication
(10) Pub. No.: US 2025/0252665 A1
(43) Pub. Date: Aug. 7, 2025

(54) GENERATING DIGITAL REPRESENTATIONS OF PHYSICAL CLAY-BASED MODELS WITH INTEGRATED DYNAMIC SUGGESTIONS AND IMAGE UPSCALING TRANSFORMATIONS

(71) Applicant: Hasbro, Inc., Pawtucket, RI (US)

(72) Inventors: Gray Bright, Cranston, RI (US); James E. Heys, JR., North Dartmouth, MA (US); Scott Clark, Barrington, RI (US); Joseph P. Bradford, Providence, RI (US); Corey Thibodeau, Providence, RI (US); Nikki Luther, Providence, RI (US)

(21) Appl. No.: 19/046,501

(22) Filed: Feb. 5, 2025

Related U.S. Application Data
(60) Provisional application No. 63/551,045, filed on Feb. 7, 2024.

(51) Int. Cl. G06T 17/00; G06Q 30/0601; G06T 7/00; G06T 11/00

(52) U.S. Cl. CPC G06T 17/00; G06Q 30/0643; G06T 7/0002; G06T 11/00

(57) ABSTRACT

A digital model generation platform populates an image repository with digital representations of physical clay-based models by generating one or more candidate images based on a combination of clay model features. The digital model generation platform integrates imaginative product displays where users engage with a program on a touch screen, allowing them to combine both pre-generated and user-requested categories to generate image models of suggested clay-based models. The displayed image, either preconfigured (i.e., in the populated image repository) or AI-generated in real time, guides users by indicating the required elements, such as colors, to recreate the model. Additionally, the mobile application introduces AI image upscaling, categorizing user-provided images (e.g., dinosaurs, superheroes) and generating more detailed upscaled images and 3D models based on the chosen category. The application outputs a 3D printer file, enabling users to create molds of upscaled 3D models.

### CROSS-REFERENCE TO RELATED APPLICATION(S)

The present application claims the benefit of U.S. Provisional Patent Application No. 63/551,045, filed Feb. 7, 2024, the entirety of which is incorporated herein by reference.

### BACKGROUND

Imaginative and creative modeling plays a pivotal role in the cognitive and emotional development of individuals, particularly children. Engaging in activities that involve shaping and molding materials, such as clay or Play-Doh, fosters essential skills ranging from fine motor coordination to spatial awareness. Beyond the physical aspects, creative modeling allows for self-expression, allowing individuals to manifest the user's thoughts, emotions, and imaginative ideas into tangible forms. The process not only nurtures artistic abilities but also enhances problem-solving skills as individuals navigate the challenges of transforming abstract concepts into concrete creations. Furthermore, creative modeling serves as a valuable medium for communication, enabling individuals to share the individual's unique ideas through the sculptures and models the user's creations.

Artificial intelligence (“AI”) models often operate based on extensive and enormous training models. The models include a multiplicity of inputs and how each should be handled. Then, when the model receives a new input, the model produces an output based on patterns determined from the data the model was trained on. Large language models (“LLMs”) are trained using large datasets to enable them to perform natural language processing (“NLP”) tasks such as recognizing, translating, predicting, or generating text or other content. A recent trend in AI is to make use of general-purpose generative AI applications built on LLMs (e.g., the ChatGPT family of OpenAI models). These sorts of models make use of a chat interface for humans to make requests to the AI. The models are able to perform tasks such as transforming images, converting visual information into textual descriptions, understanding the visual content of images, generating coherent and descriptive textual representations, and generating realistic images from textual descriptions. At the time of filing, general-purpose generative AI's first attempt at responding to a user's queries is middling and requires query refinement from the user. Over the course of a given chat session, the user refines their queries, and the general-purpose model provides a better response.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1A is a screenshot illustrating the digital model generation platform as a product display.

FIG. 1B is a screenshot illustrating the example product display of FIG. 1A in a store end-cap environment.

FIGS. 2A and 2B are block diagrams illustrating example environments of a validation engine of the digital model generation platform.

FIG. 3A is a screenshot illustrating a user interface for the product display of FIG. 1A.

FIG. 3B is a screenshot illustrating a user interface for the product display of FIG. 1A after receiving user input.

FIG. 4A is a screenshot of an image generation engine of the digital model generation platform, illustrating receiving a picture of components used for a user's modeling creation.

FIG. 4B is a screenshot of the image generation engine of FIG. 4A in a product display, illustrating receiving an unreadable user input.

FIG. 4C is a screenshot of the image generation engine of FIG. 4A illustrating using image recognition to translate the picture of FIG. 4A into a digital format.

FIG. 5A is a screenshot of an example mobile application illustrating the digital model generation platform presenting components needed for a modeling creation in a digital format for manual selection.

FIG. 5B is a screenshot of the mobile application of FIG. 5A generating a set of categories for the modeling creation.

FIG. 6 is a block diagram illustrating an example environment of an image generation engine of the digital model generation platform used to populate an image repository with images of modelling creations.

FIG. 7A is a screenshot illustrating an example environment of the image repository of FIG. 6.

FIG. 7B is a screenshot illustrating an example entry of the image repository of FIG. 6.

FIG. 8A is a screenshot illustrating an example set of color filters of the image repository of FIG. 6.

FIG. 8B is a screenshot illustrating an example set of categorical filters of the image repository of FIG. 6.

FIGS. 9A-9F are screenshots illustrating example instruction screens including instructions to view images of modelling creations in the image repository of FIG. 6.

FIG. 10 is a flowchart illustrating a process of using the digital model generation platform to populate an image repository with images of modelling creations.

FIG. 11A is a screenshot of an example mobile application illustrating an image transformation engine of the digital model generation platform receiving a user picture of a tangible modeling creation.

FIG. 11B is a screenshot of the mobile application of FIG. 10A illustrating selecting user preferences for a digital transformation of the tangible modeling creation.

FIG. 11C is a screenshot of the mobile application of FIG. 11A illustrating the digital model generation platform generating the digital transformation of the tangible modeling creation using a generative artificial intelligence (AI) model.

FIG. 11D is a screenshot of the mobile application of FIG. 11A illustrating user customization on a user interface of the digital model generation platform of FIGS. 2A and 2B related to the digital transformation of the tangible modeling creation.

FIG. 11E is a screenshot of the mobile application of FIG. 11A illustrating a customized digital profile of the digital transformation of the tangible modeling creation.

FIG. 12A is a screenshot illustrating one embodiment of a front view of a suggested modeling creation in an Standard Triangle Language (STL) file for 3D printing.

FIG. 12B is a screenshot illustrating one embodiment of a back view of the suggested modeling creation of FIG. 12A in an STL file compatible for 3D printing.

FIG. 12C is a screenshot illustrating one embodiment of a bottom view of the suggested modeling creation of FIG. 12A in an STL file compatible for 3D printing.

FIG. 12D is a screenshot illustrating one embodiment of a top view of the suggested modeling creation of FIG. 12A in an STL file compatible for 3D printing.

FIG. 13 is an image illustrating one embodiment of a 3D-printed mold of the suggested modeling creation of FIG. 12A printed from an STL file.

FIG. 14 is an image illustrating one embodiment of a physical representation of the suggested modeling creation of FIG. 12A constructed using the 3D-printed mold of FIG. 13.

FIG. 15 is a flowchart illustrating a process of using the image transformation engine of the digital model generation platform to generate digital representations of modelling creations.

FIG. 16 is a block diagram illustrating an example computer system, in accordance with one or more embodiments.

FIG. 17 is a high-level block diagram illustrating an example AI system, in accordance with one or more embodiments.

### DETAILED DESCRIPTION

Traditional modeling activities with materials such as clay or Play-Doh often face limitations, especially when it comes to guiding young users through the creative process. Children struggle to translate the child's imaginative ideas into tangible creations due to a lack of skill in molding the child's creations, leading to frustration and a potential loss of interest. Moreover, parents or guardians find it challenging to assist in this process due to varying skill levels and the subjective nature of interpreting a child's vision. For example, what a parent thinks looks like an octopus is an alien in the child's mind. Existing systems typically lack the assistance needed to identify and guide the user's creative intent. The lack of assistance extends to retail environments, where users must make the first decision to purchase the materials needed for modeling, which leaves potential users without a user-friendly and informative guide for the user's creative endeavors.

The present system (hereinafter “digital model generation platform”) addresses these challenges by integrating imaginative product displays, such as Play-Doh, with a touch screen element. Users engage with a program on the touch screen, allowing users to combine both pre-generated and user-requested categories to generate image models of suggested creations with the imaginative product. The displayed image, either preconfigured or AI-generated in real time, also guides users by indicating the required or suggested elements, such as colors or specific products, to recreate the model. Users are able to then choose to print the image from the in-store end cap or receive it via email. Users are able to also connect to a mobile app for further exploration. Users are able to also receive a file compatible with a 3D printer to generate a 3D mold and create a modeling creation using the aid of the 3D mold. Additionally, users are able to input an image of an already made tangible creation using the product, and the digital model generation platform directs a generative AI model to upscale the image to create a customized digital character profile for the tangible creation. For example, a child that inputs an image that they believe to be an alien is enabled to specify that the image is an alien, and the digital model generation platform upscales the image using the context of an alien (as opposed to, for example, an octopus).

Furthermore, existing systems for validating and curating image content typically focus on technical quality metrics (e.g., image resolution, pixel density, and so forth) rather than educational value or achievability. Existing systems create a disconnect between the suggested models and a user's actual ability to recreate them with physical materials, which results in repositories filled with unrealistic or overly complex examples that discourage rather than inspire young creators. Further, in the context of recreating image content using physical materials, the challenge extends to ensuring that all generated or stored images align with the physical properties and possibilities of actual modeling materials (i.e., if a creator only has blue Play-Doh, the creator would be unable to re-create an image indicating red Play-Doh). Without ensuring that generated content matches appropriate skill levels and material constraints, young users become frustrated when attempting to replicate suggested creations that are beyond their capabilities.

In addition, conventional approaches to building and maintaining image repositories were limited by the inability to efficiently process large-scale requests for image generation. For examples, when faced with tens of thousands of simultaneous image generation requests, traditional systems struggle to maintain consistent quality standards for the generated image(s) of each request, resulting in bottlenecks that limit the scalability of image repository population. In particular, to verify each image populated in the image repository, traditional systems manually run the image through validation checks and regenerate non-satisfactory images. The time taken to verify and regenerate non-satisfactory images causes significantly slower processing times on the user's end. Thus, traditional systems are unable to accommodate further requests until each request has been manually validated.

The digital model generation platform further addresses these challenges using a validation engine to ensure that generated images align with predefined criteria, such as user capabilities and available materials. The digital model generation platform generates a set of candidate images depicting clay-based models based on requested features, and uses one or more artificial intelligence (AI) models to validate the candidate images against predetermined content restrictions corresponding to the actual modeling materials available to the user. Specifically, the digital model generation platform determines a degree of compliance between the generated images and the predetermined content restrictions. Only when the compliance meets a predefined threshold are the images presented to users and/or populated into the image repository.

Thus, the suggested creations remain achievable with the user's available materials and skill level. For example, when a user indicates they have only blue modeling clay available, the digital model generation platform restricts generated suggestions to creations achievable with that specific color. Similarly, the digital model generation platform considers age-appropriate complexity levels so that the suggested models match the user's capabilities and thus inspire rather than frustrate young creators. For example, while a technically high-quality image shows an intricate dragon with multiple thin appendages that would be difficult to construct with Play-Doh, the system's validation engine ensures that suggested models have achievable structures that consider the physical limitations of the modeling material.

Further, the digital model generation platform can process a large volume of requests efficiently by automatically validate generated images against multiple parameters while simultaneously processing new generation requests to enable a rapid population of image repositories. Even when processing thousands of image requests simultaneously, each generated image maintains compliance with predetermined content restrictions and validation parameters without creating processing bottlenecks or compromising validation accuracy.

While some embodiments of the present modeling interface are described in detail for use with modeling activities (such as Play-Doh), the system and method disclosed herein may find application in various domains beyond creative modeling. The principles and functionalities disclosed can be adapted for guiding creative processes in diverse contexts, including drawing, imaginative physical media products, digital animation, and any other environments where user-generated content is prevalent. The examples provided in this paragraph are intended as illustrative and are not limiting. Any other type of creative process referenced in this document, and many others unmentioned are equally appropriate after appropriate modifications.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description that references the accompanying figures follows. The scope of the invention is limited only by the claims and the invention encompasses numerous alternatives, modifications, and equivalents. Numerous specific details are set forth in the following description in order to provide a thorough understanding of the disclosure. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Example Embodiments of the Digital Model Generation Platform

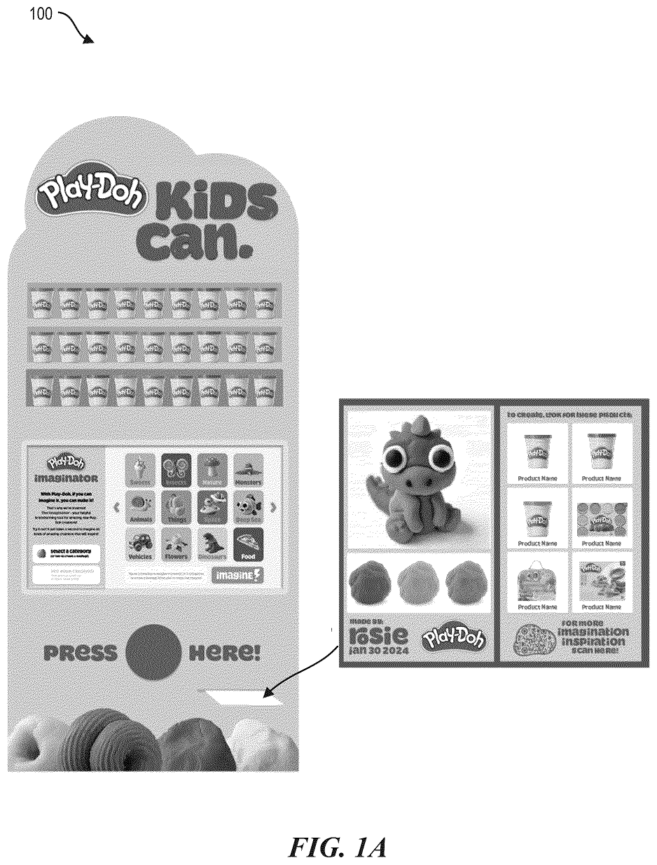

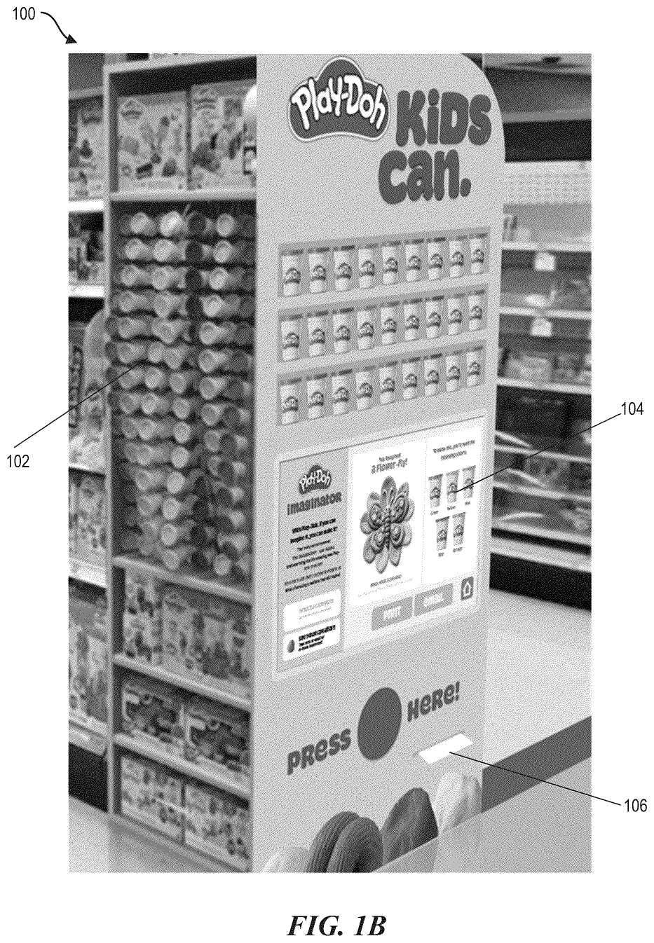

FIG. 1A is a screenshot illustrating the digital model generation platform as a product display 100. FIG. 1B is a screenshot illustrating the example product display 100 of FIG. 1A in a store end-cap environment. In some embodiments, the product display is for a product 102 that encourages imagination, such as Play-Doh, and includes a touch screen element. In some embodiments, the digital model generation platform is designed to enable users to combine categories, pre-generated and/or user-requested, to generate image models of suggested modeling creations.

In some embodiments, the user first approaches the product display and is greeted by a screen interface 104 inviting user interaction. In some embodiments, the screen interface is a touch screen that receives user input through physical touch. The user is prompted to select an option within categories from a list of pre-generated options or request specific themes for the user's creation. In some embodiments, each pre-generated option is accompanied by a visually representative icon or image to provide users with an indication of the option's essence and potential creative possibilities.

The user selects one or more options from a repository of pre-existing options within each category (e.g., different colors, creation-types, themes). In some embodiments, the repository of pre-existing options is centrally stored within the digital model generation platform's database. In some embodiments, each option is associated with metadata, including thematic keywords, visual representations, and/or additional attributes to aid in the categorization of similar options and retrieval (e.g., “Pizza” and “Ice Cream” are both associated under “Food”). In some embodiments, the repository is subject to periodic updates and maintenance to reflect evolving user preferences, emerging trends, and/or new thematic additions. In some embodiments, the digital model generation platform monitors user interactions and feedback, identifying popular categories and trends to inform the updating process. Additionally, administrators, in some embodiments, manually add, remove, or modify categories in the repository based on factors such as market research and user engagement metrics (e.g., if the dinosaur category is picked below a certain percentage, the category is removed). In some embodiments, users are able to personalize the selection of pre-existing categories based on the user's preferences and interests. For example, customization features include the ability to bookmark favorite categories, create personalized collections, or filter categories based on specific criteria. User customization is completed on a per-session basis or maintained inter-session.

In some embodiments, the repository is hosted locally on the product display system. In some embodiments, the repository is hosted on a cloud-based platform to facilitate real-time updates and synchronization across multiple product display installations (e.g., multiple product displays throughout multiple stores would update at the same time). The cloud-based infrastructure ensures scalability and uniformness throughout the product displays, accommodating fluctuations in user traffic and demand without compromising system performance.

For instance, in a product display, pre-defined categories include color, creation-type, theme, and so forth. Under the color category, users have options such as red, blue, yellow, etc., allowing the user to select the user's desired color palette for the user's creations. Creation-type categories encompass specific creations that the user would like to include in the final creation (e.g., a clay-based model), such as octopus, rainbows, and butterflies. Theme categories include overarching concepts such as dinosaurs, desserts, and outer space. Users, in some embodiments, select at least one option from each category on the screen interface. In some embodiments, the user is allowed to leave one or more categories blank (e.g., which can be treated as no filter on the particular category). In some embodiments, the user is able to select multiple options from each category (e.g., select red and blue from the color category).

In some embodiments, the digital model generation platform accommodates user-requested categories or options, allowing individuals to introduce the individual's ideas and preferences into the creative process. Users type in keywords or phrases (e.g., via a touchscreen interface) representing the user's desired themes to introduce personalized elements into the creative process (e.g., “Pizza”). In some embodiments, the user input is a prompt (e.g., command set or instruction set) to be input in the digital model generation platform. In some embodiments, upon receiving user input, the digital model generation platform extracts relevant themes or context from the text. The digital model generation platform identifies, from the input text, terms and phrases that signify thematic concepts or preferences. In some embodiments, the digital model generation platform uses one or more natural language processing (NLP) algorithms to identify the semantic context of the input text and discerns the intended meaning behind user-provided keywords based on the grammatical structure and/or syntactic dependencies within the user-provided phrases to identify how words relate to each other.

In some embodiments, a user provides an image as input. For example, in a product display, a user uploads an image or a hand-drawn sketch of an animal or object the user wishes to recreate using Play-Doh. The digital model generation platform uses the visual content of the uploaded image to identify features, shapes, and colors, to extract contextual information. For example, feature extraction extracts relevant visual features from the image using deep learning-based convolutional neural networks (CNNs) or similar techniques. The networks are trained on vast datasets of images and have learned to recognize patterns, shapes, textures, and colors in visual data. Based on this analysis, the digital model generation platform then generates suggestions and/or provides guidance on how to replicate the image using the product. In some embodiments, the image input is one of multiple categories used by the digital model generation platform to generate suggestions and/or provide guidance.

Upon selecting categories, the digital model generation platform evaluates the chosen categories to recognize patterns and themes relevant to the user's preferences. For image inputs (such as a user-inputted image), in some embodiments, the digital model generation extracts features, shapes, textures, color palettes, and so forth from visual representations associated with the selected categories, as described above. For textual inputs (such as user-inputted text), NLP algorithms analyze textual descriptions or keywords associated with the chosen categories, identifying semantic patterns and thematic elements embedded within the text. In some embodiments, the digital model generation platform uses machine learning models that are trained on datasets of categorized patterns to enable the machine learning models to identify recurring patterns that align with the user's preferences. For example, the patterns encompass visual characteristics such as geometric shapes, textures, and color schemes, as well as thematic elements like genres, styles, and subject matter.

In some embodiments, extracted keywords from a user input are later integrated into the digital model generation platform's pre-defined category repository, either as standalone categories or as supplementary tags associated with existing themes. For example, a user inputs the keyword “Pizza,” the keyword “Pizza” is recognized by the digital model generation platform as a distinct thematic concept. “Pizza” is then integrated into the digital model generation platform's category repository as a standalone category, representing a unique theme for users to explore and incorporate into the user's creations. Users select the “Pizza” category from the screen interface and access a range of pre-existing templates, suggestions, and creative prompts related to Pizzas. Alternatively, the keyword “Pizza” is associated as a supplementary tag with existing themes or categories already present in the digital model generation platform's repository. For example, the keyword “Pizza” is tagged as a subcategory within the broader theme of “Circle Shapes” or “Things Involving Cheese.” Users exploring related themes like pasta or pies would encounter suggestions or prompts specifically tailored to include elements related to pizzas.

A cache system, in some embodiments, stores a subset of the most popular or recently accessed options in a temporary storage buffer. By storing frequently accessed options locally within the cache, the digital model generation platform minimizes the need for repeated retrieval from the main database, reducing latency and increasing the efficiency of category retrieval during user interactions. In some embodiments, the cache system incorporates mechanisms to manage cache size by removing older or less relevant categories to make room for new entries.

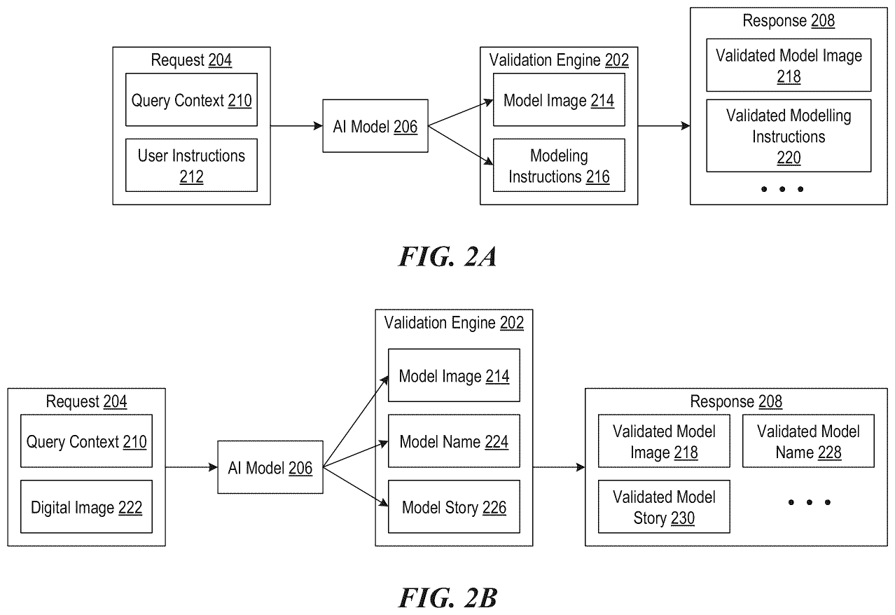

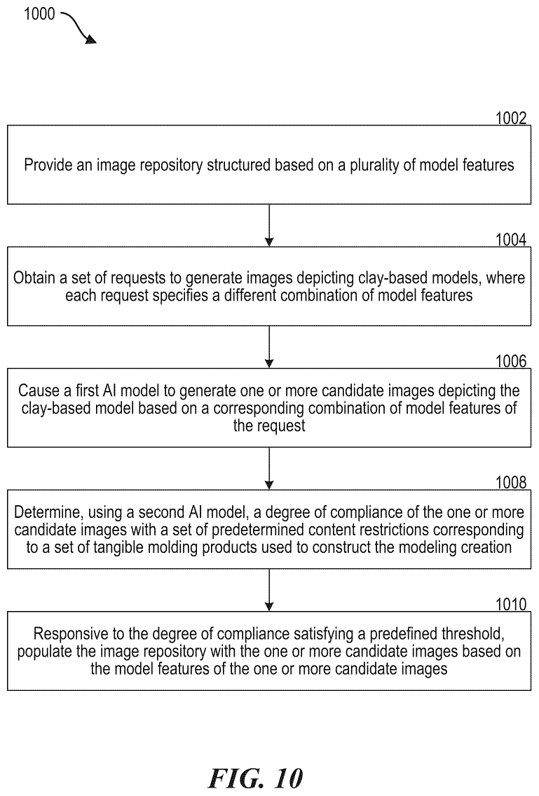

In some embodiments, users have the option to customize the user's selection process further by adjusting parameters such as theme intensity, complexity level, and/or style preference to tailor the selection to the user's specific creative vision. In some embodiments, the user has the option to adjust the intensity of the selected theme, ranging from subtle hints to a more dominant inclusion of the selection. For instance, the user selects “Outer Space” in the “Theme” category. The user selects a low intensity for a subtle influence of the outer space theme in the suggestion, or the user opts for a high intensity to fully embrace the theme in the suggested modeling creation. Additionally, in some embodiments, users customize the complexity level of the user's selected theme based on the user's skill level and desired challenge. In some embodiments, the user opts for simpler, beginner-friendly creations with basic shapes and features, or chooses more intricate designs with elaborate details and structures for a greater challenge. Methods of validating generated images against the selected complexity level (e.g., target skill level) are discussed with reference to FIGS. 2 and 10. In some embodiments, users personalize the user's selection based on style preferences, such as choosing between realistic or abstract interpretations of the theme. For the “Outer Space” category, users would opt for a realistic depiction, or select a more abstract and cartoonish approach.

In some embodiments, as users make the user's selections, the screen interface provides dynamic feedback, updating in real-time to reflect the user's choices. For example, a user chooses the theme “Animal Kingdom.” The screen interface displays “Let your imagination run WILD!” to encourage the user to continue through the selection process and foster excitement. In some embodiments, visual cues appear on the screen, such as highlighted categories or animated transitions, to make the selection process intuitive and engaging.

Based on the user's selections, in some embodiments, the digital model generation platform generates an image of a suggested modeling creation that aligns with the user's preferences and creative vision. For example, if the user inputs categories such as “Outer Space,” the digital model generation platform generates an image featuring celestial bodies such as a star or a planet. In some embodiments, the product display includes a set of tangible products within the display. In some embodiments, the image depicts the subject made of the same material as the product within the product display (e.g., a star made of Play-Doh on a Play-Doh product display). In some embodiments, the digital model generation platform personalizes the generation based on individual user preferences and interaction history. In some embodiments, the interaction history is limited to a single session. User interaction data, including past selections, feedback, and engagement patterns, are leveraged to tailor the generation to each user's preferences. By incorporating user-specific preferences into the generation, the digital model generation platform generates suggestions and content that resonate more closely with the user's creative vision and interests.

In some embodiments, the digital model generation platform chooses from a pre-existing image dataset to generate the image of the suggested modeling creation. The datasets contain example images of various design concepts, themes, and styles of various combinations of categories that allow the digital model generation platform to draw upon, randomly or non-randomly, during the generation process.

In some embodiments, the suggested modeling creation image is generated by a generative AI model in real-time. In some embodiments, the generative AI model is trained using a portion of a preprocessed dataset of example modeling creation images. During training, the generative AI model learns to generate images by optimizing the model's parameters to minimize a loss function that measures the difference between the generated images and the example modeling creation images. The generative AI model receives the user's selected categories and user-inputted images and/or text, and outputs a suggested modeling creation image. For example, the generative AI model receives the parameters that the color is blue and the theme is outer space. The generative AI model outputs an image of a blue alien that appears to be constructed out of a molding product (e.g., Play-Doh).

As users interact with the digital model generation platform and provide feedback on the generated images, the information is used to iteratively refine and improve the performance of the generative AI model. For example, reinforcement learning or fine-tuning on user feedback enhances the model's ability to generate better quality and more personalized modeling creation images over time.

The screen interface displays the generated image model, providing visual guidance on the required or suggested elements to recreate the suggested creation. The visual guidance includes specific products or other components necessary for the user to replicate the model. For example, for an image of a blue alien, the required elements include blue Play-Doh. In some embodiments, using the visual guidance provided by the touch screen interface, the user accesses the product display and selects the necessary products within the product display (e.g., picking up the blue Play-Doh from the store end-cap display). The user is then able to replicate the suggested creation using the selected products, following the guidance displayed on the screen. In some embodiments, the visual guidance also includes suggested elements that are not required to construct the suggested modeling creation image, but would aid the user in doing so. For example, if the suggested model is a pirate ship, the digital model generation platform suggests adding cannons, treasure chests, or pirate figurines to embellish the scene.

In some embodiments, once the creation is complete, the user has the option to print the suggested modeling creation image and/or visual guidance directly from the end cap onboard printer 106 (e.g., via an onboard photo or inkjet printer) or receive the suggested modeling creation image and/or visual guidance via email. In some embodiments, if the user chooses to receive the materials via email, the digital model generation platform connects the user to a mobile app for further development and exploration of the user's creation. To facilitate personalization and customization of the printout, in some embodiments, users are able to input the user's name or other additional information, such as the date, through the screen interface. Upon selecting the option to print the suggested modeling creation image, users, in some embodiments, are prompted to enter the desired information via text input fields or dropdown menus. Once the user inputs the user's desired information, in some embodiments, the application integrates the information into a printout template. In some embodiments, users have the option to customize the layout and formatting of the printout template, allowing the user to adjust the placement, font style, and size of the user's name or other details.

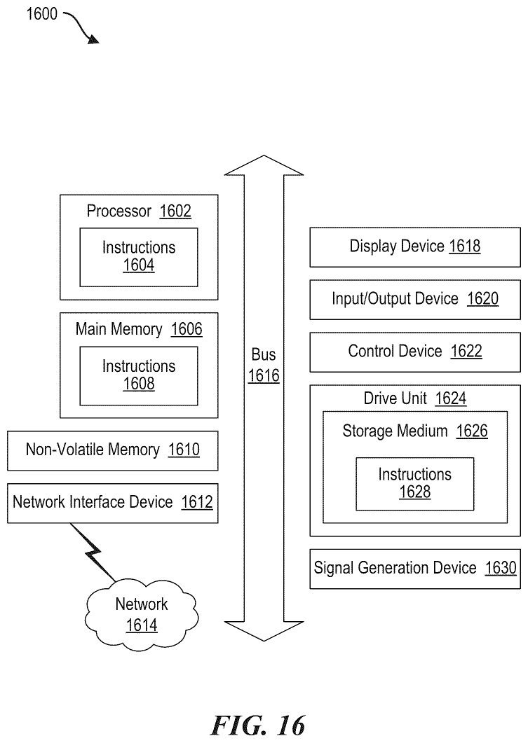

FIGS. 2A and 2B are block diagrams illustrating example environments of a validation engine 202 of the digital model generation platform. The environment of FIG. 2A includes a request 204, an AI model 206, and a response 208. The request 204 includes, for example, a query context 210 and user instructions 212. The validation engine 202 includes model image 214 and modelling instructions 216. The validation engine 202 is implemented using components of the example computer system 1600 illustrated and described in more detail with reference to FIG. 16. The response 208 includes a validated model image 218 and validated modelling instructions 220.

The request 204 operates as an input to the validation engine 202. Within the request, the query context 210 provides contextual parameters that direct how the AI model 206 should interpret and process the request, such as specifying a target skill level (e.g., children ages 6 and under), a target knowledge domain (e.g., only topics found within content rated within a certain category, such as TV-Y), output parameters (e.g., output format, tone), and other constraints discussed in further detail with reference to FIG. 10. The user instructions 212 contain specific modeling parameters and requirements input by the user, which includes, for example, details about desired features, characteristics, or specifications for the model image output (e.g., a dinosaur that is green and black).

A target skill level refers to the user's ability to recreate physical models, which includes factors such as fine motor skills, spatial awareness, previous experience with modeling materials (e.g., younger users have less experience with molding materials), and so forth. The digital model generation platform considers the user's capabilities when validating and generating suggestions to ensure the complexity of suggested creations matches the user's developmental stage and modeling abilities. An objective measure of a skill level required as determined from a picture of a clay model is the relative size of the feature of that model. Larger features typically require less fine motor skill precision to achieve.

Similarly, a target knowledge domain encompasses the thematic scope and content appropriateness of generated suggestions. The digital model generation platform ensures that generated content aligns with age-appropriate themes and concepts, similar to content rating systems used in other media. The digital model generation platform considers factors such as the complexity of themes, appropriateness of subject matter, relevance to the user's interests and understanding level, and so forth. For example, the digital model generation platform restricts suggestions to simple, recognizable objects for younger users while allowing more complex or abstract concepts for older users.

Output parameters define the specific characteristics and format of the generated suggestions. Output parameters include aspects such as the visual representation style, the level of detail in the instructions, the presentation format of the suggestions, and so forth. The digital model generation platform uses the parameters to ensure the output is both comprehensible and achievable for the target user. For instance, the digital model generation platform adjusts the complexity of visual guides, the number of steps in instructions, and/or the level of detail in the suggested models based on the user's capabilities.

Other constraints include physical limitations of the modeling materials, such as the available colors and quantities of the moldable material, the structural possibilities of the medium, the practical feasibility of suggested creations, and so forth. The digital model generation platform validates generated content against these constraints to ensure suggestions remain achievable with the available materials. For example, if a user has limited color options, the digital model generation platform restricts suggestions to creations that can be accomplished with those specific colors, preventing frustration from attempting to recreate models that require unavailable materials

The AI model 206 is implemented as a neural network-based generative model trained on modeling data and intakes the input query context 210 and user instructions 212. In some embodiments, the AI model 206 is a pre-trained LLM. The AI model 206 generates initial outputs including the model image 214, which represents a visual representation of the requested model, and modeling instructions 216 that provides step-by-step guidance for recreating the model using physically tangible molding materials (e.g., clay, Play-Doh).

The validation engine 202 performs a set of validation checks on the AI-generated outputs (i.e., the model image 214 and the modeling instructions 216) before producing the response 208. The validation engine 202 verifies that the model image 214 meets predefined quality standards (such as those defined by the query context 210), checks for consistency with the user instructions 212, and so forth. The validated model image 218 represents the approved visual output that has passed the validation criteria within the set of validation checks. Similarly, the validated modeling instructions 220 contain verified guidance that has passed the validation criteria within the set of validation checks. For example, the validated model image 218 and validated modeling instructions 220 have been confirmed to be age-appropriate, skill level appropriate, realizable using a given set of physically tangible molding materials, aligned with the intended use case, and so forth. Examples of validation checks and methods of validating using the validation engine are discussed with further reference to FIG. 10.

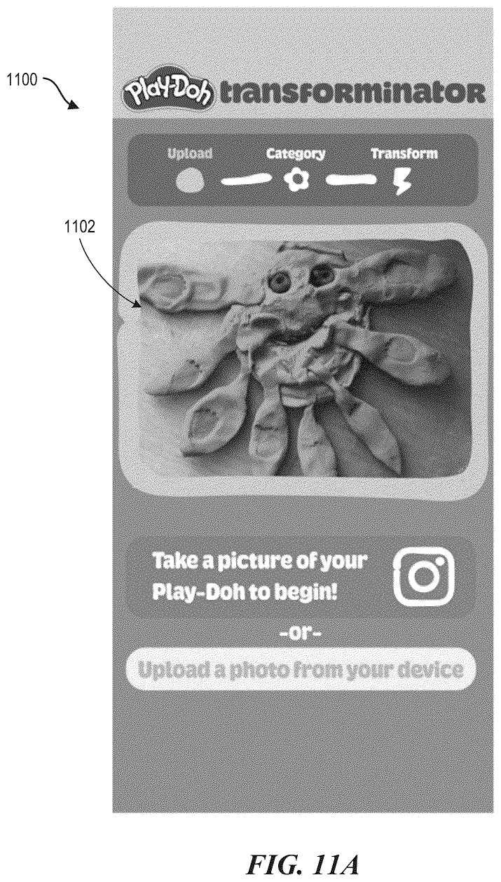

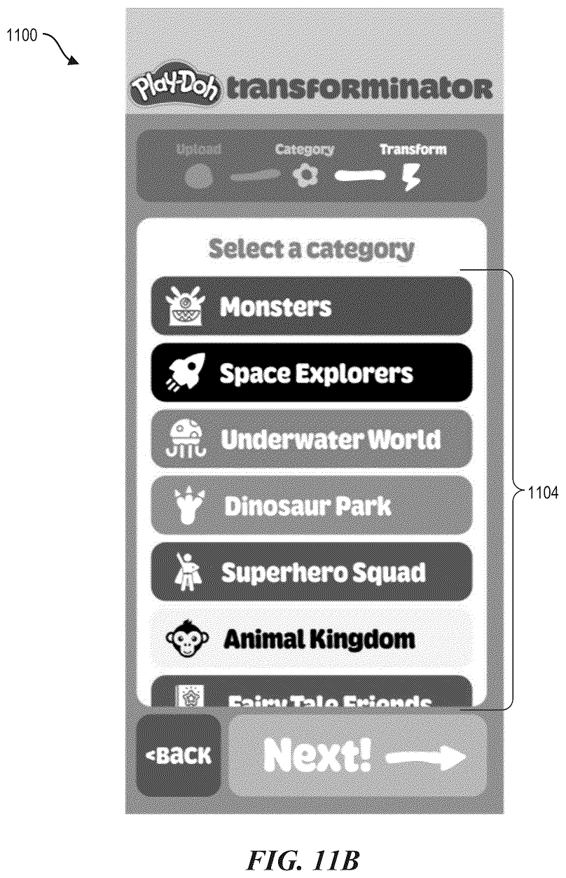

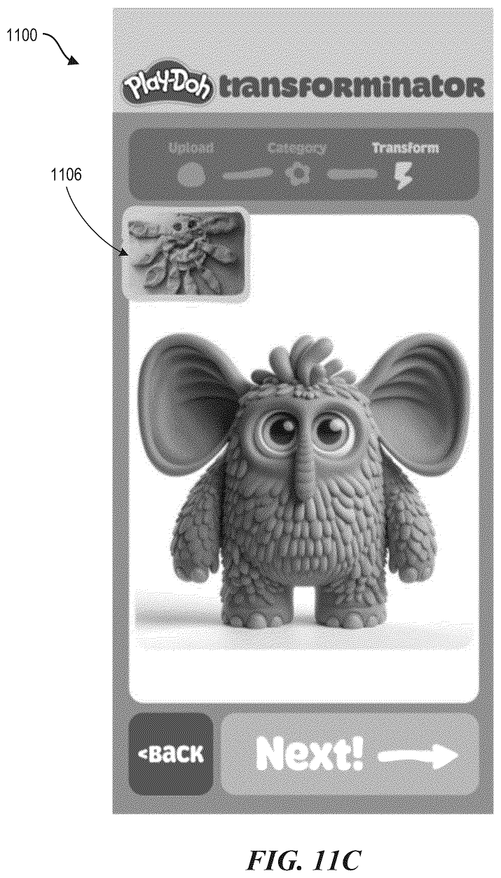

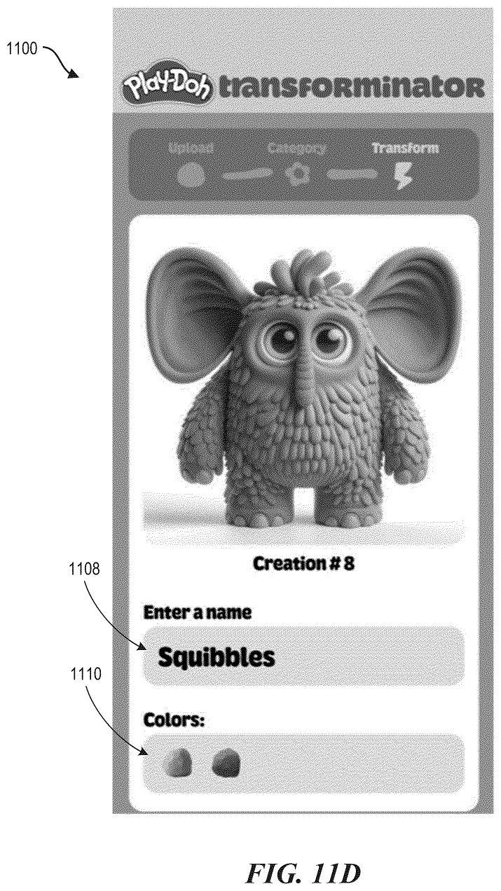

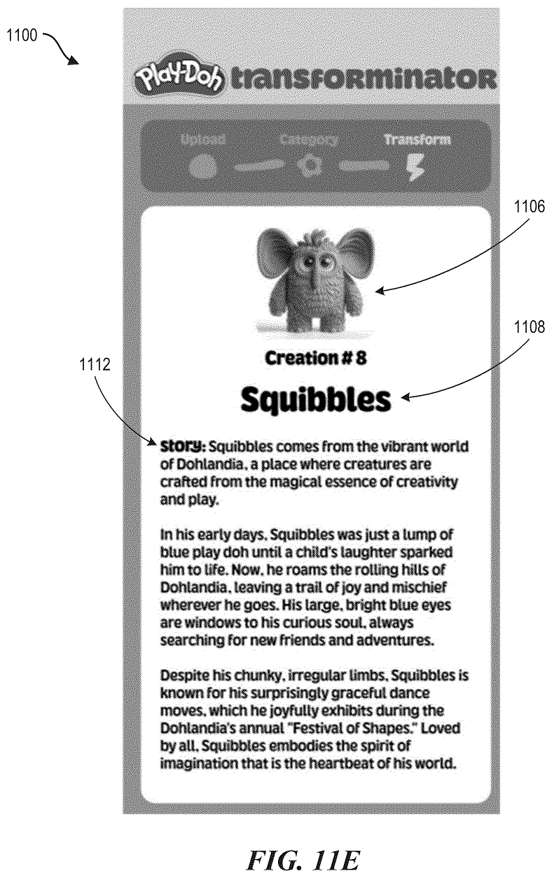

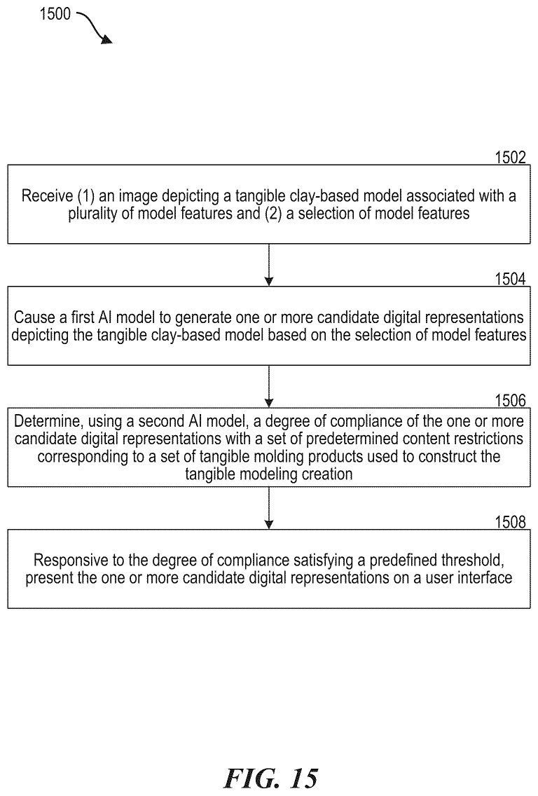

The environment of FIG. 2B similarly includes the request 204, the AI model 206, and the response 208. The request 204 in FIG. 2B includes, for example, the query context 210 and a digital image 222. The validation engine 202 includes the model image 214, a model name 224, and a model story 226. The response 208 includes the validated model image 218, the validated model name 228, and the validated model story 230. The digital image 222 is, for example, a user-submitted image of a physical model creation (e.g., an image of a user-made Play-Doh creation). The validation engine 202 generates the model image 214, in some embodiments, by upscaling the input digital image 222 (discussed in further detail in FIGS. 11A-15). In some embodiments, the validation engine 202 generates a model name 224 and model story 226 along with the model image 214. For example, the AI model 206 generates the model name 224 based on the visual content of the digital image 222 and the content of the query context 210 to produce appropriate descriptive titles (e.g., naming a picture indicating a flower and a butterfly as a “flutter-fly”). The model story 226 is transforms visual features and contextual information into narrative descriptions using methods discussed with reference to FIG. 15. For example, when processing a user's clay-based model, the digital model generation platform generates detailed backstories like “In his early days, Squibbles was just a lump of blue Play-Doh until a child's laughter sparked him to life” due to recognition of the blue clay figure. The response 208 in FIG. 2B includes, similar to FIG. 2A, validated AI-generated outputs such as the model image 218, the model name 228, the validated model story 230, and so forth. Examples of validation checks are discussed with further reference to FIG. 15.

### Example Embodiments of Generating Images Using the Digital Model Generation Platform

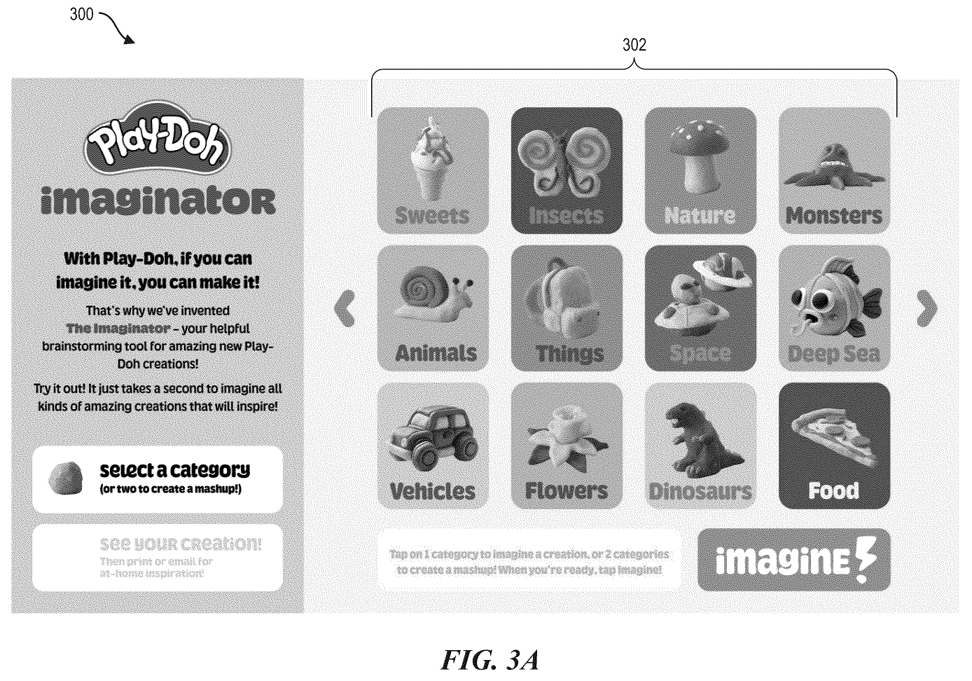

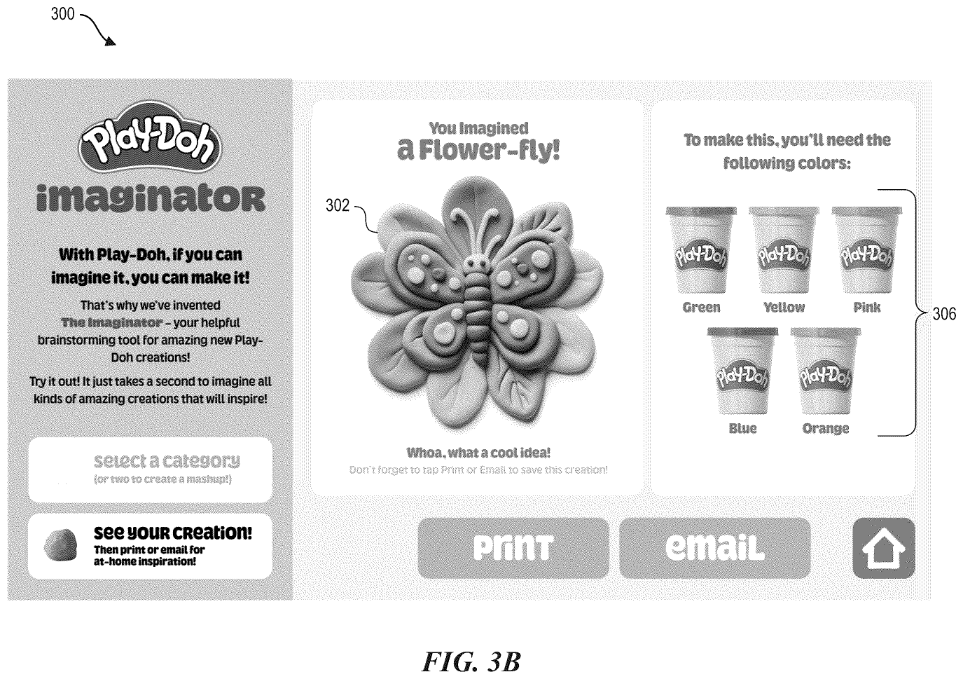

FIG. 3A is a screenshot illustrating a user interface 300 for the product display of FIG. 1A. In some embodiments, the user interface allows users to tap on individual categories displayed on the screen. Each category represents a specific theme, style, or subject matter, such as animals, vehicles, or outer space. In some embodiments, the category selection mechanism on the product display is implemented using touch-sensitive input detection that enables users to interact with the interface by physically tapping on the desired categories.

In some embodiments, users have the option to tap on a single category option to envision a creation inspired by that specific theme. Upon tapping an option, the digital model generation platform dynamically generates an image of a suggested modeling creation corresponding to the single selected option. Once the user's single option is selected, the digital model generation platform leverages a generative AI model to generate an image based on the chosen option or chooses an image from a pre-defined dataset, as further discussed in FIGS. 1A and 1B. The generated image is then rendered and displayed on the interface in real-time for the user to view.

In some embodiments, users tap on two or more categories (e.g., a butterfly and a flower) to create an image that combines the selected categories. By selecting two or more distinct categories, users are able to blend elements from each category into one output. Upon receiving multiple category selections, the digital model generation platform accesses a repository of pre-existing images corresponding to each category. The images, in some embodiments, include a variety of flower and butterfly representations sourced from a curated dataset or generated by AI models. The digital model generation platform then uses generative adversarial networks (GANs) or other neural networks to synthesize a mashup image that combines elements from both categories. For example, the digital model generation platform blends the floral patterns of a flower with the wing structure of a butterfly to create a blended image. The synthesized mashup image is rendered in real-time by the digital model generation platform and, in some embodiments, displayed on the interface for the user to view and interact with. In some embodiments, the interface provides users with immediate feedback opportunities by allowing the user to visualize the mashup creation and make further adjustments or provide feedback if desired.

The generation of the image of the generative AI model, in some embodiments, is directed by query context. Query context includes both the query to the generative AI model (e.g., the user-requested query) along with the query's contextual information. The query's contextual information controls the manner in which the queries should be interpreted. In some embodiments, the digital model generation platform incorporates query context into the generative AI model to direct the generative AI model to generate a suggested modeling creation that is realized using available materials queried from a database. By integrating real-time inventory data and material availability information the digital model generation platform, the digital model generation platform dynamically adjusts the generated image to only include elements that align with the user's query context and are currently accessible. For example, if a user queries for modeling creation materials available in the user's local store or online inventory, the digital model generation platform filters the generated image to include only those materials that are currently in stock or readily obtainable. The query context ensures that users receive practical and actionable suggestions that take into account the availability of materials. In some embodiments, the query context is hidden from the user.

FIG. 3B is a screenshot illustrating a user interface 300 for the product display of FIG. 1A after receiving user instructions. In some embodiments, once the image is generated in real-time based on the user's category selections, the image of the creation is displayed on the interface for immediate viewing and interaction. In some embodiments, in addition to displaying the image, the interface also includes instructions regarding the materials required or suggested to recreate a tangible version of the digital image. By referencing a database of available materials, the digital model generation platform identifies and lists the specific items needed to recreate the generated image. In some embodiments, the interface provides users with options to save, share, or disseminate the image. Users have the choice to print the image directly from the interface and/or opt to send it via email for future reference.

In the depicted example of FIG. 3B, the user selected the categories insects and flowers, which resulted in the program output of a “flower-fly.” The flower-fly is either pre-generated or generated by the AI engine in real time based on the selection of the chosen categories, insects and flowers.

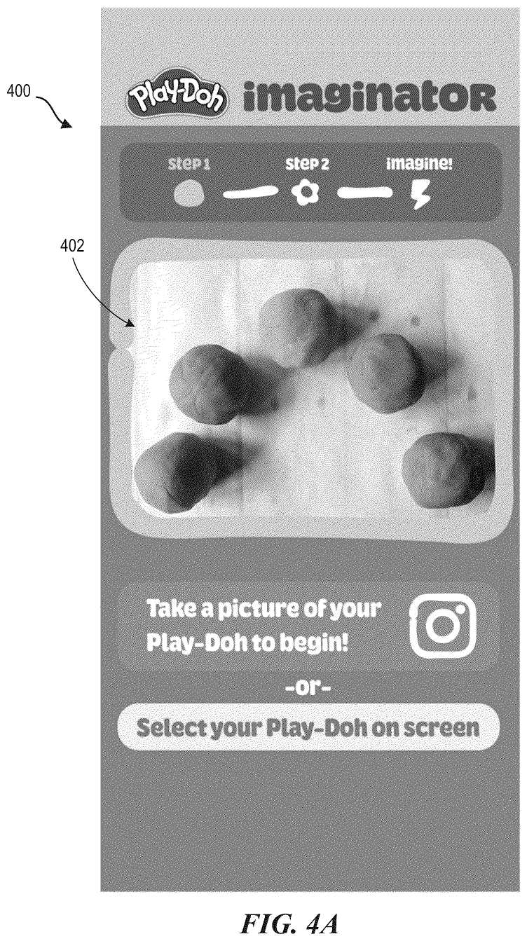

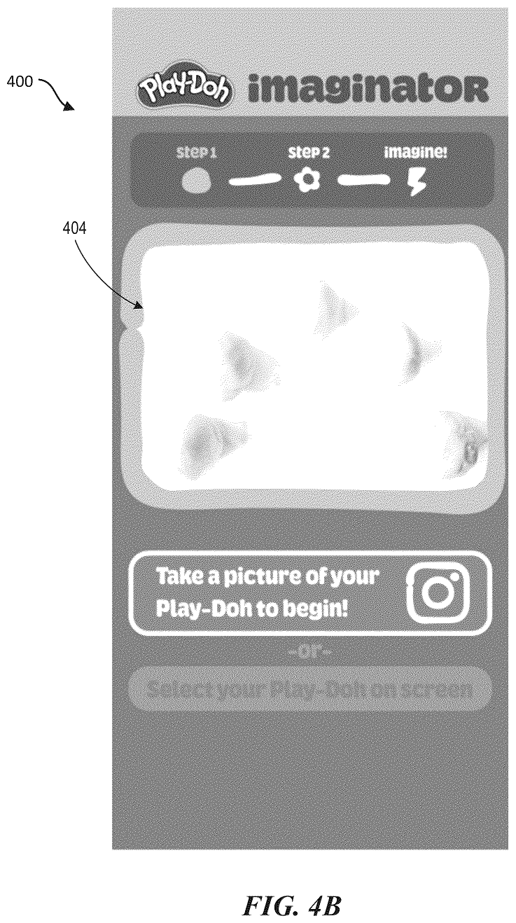

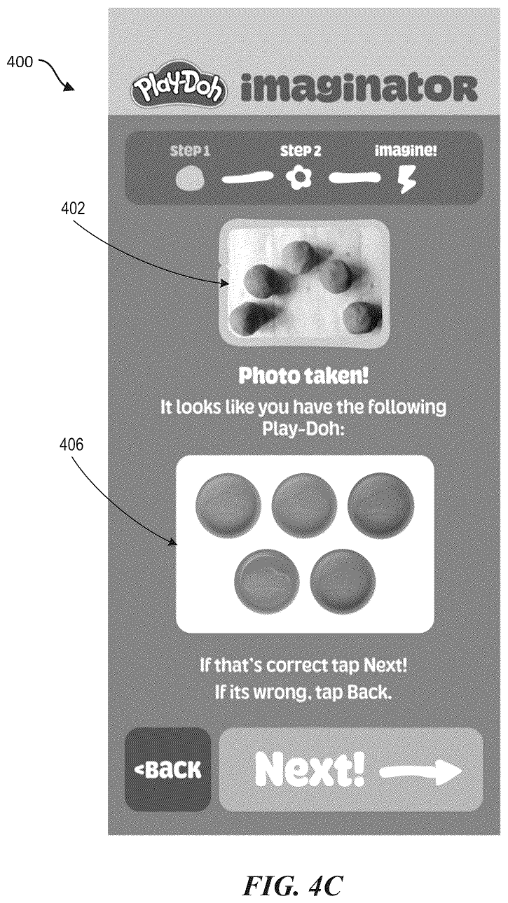

FIG. 4A is a screenshot of an image generation engine 400 of the digital model generation platform, illustrating receiving a picture of components used for a user's modeling creation. The user interface of the application facilitates the uploading and processing of component images. In some embodiments, users capture images of the components using the user's device's camera or upload existing images from the user's gallery.

The context of the screen shot is from a mobile application interface away from a retail location end cap display. At an end cap display the application software is able to suggest colors of the imaginative product as there is a display of modelling clay presently available to select from. Via the mobile application in unknown circumstances, the user instead is enabled to dictate the available materials.

The AI model uses the image to identify what modelling elements that the user has available and then is able to suggest creations based thereon. This process flow is in contract with that of FIG. 3B where the user is told what modelling elements they will need (as the assumption is the user is at a retail store and can obtain any modelling option in the display). Thus, in the present figure, resulting suggestions by the AI are limited by available colors. The computer-driven suggestions are predominantly governed by available color options and volume (e.g., the size of the balls depicted) within user selected categories as opposed to corners or structural components (as is known in the art).

FIG. 4B is a screenshot of the image generation engine 400 of FIG. 4A in a product display, illustrating receiving an unreadable user input. In some embodiments, when the user submits an unreadable user input due to factors such as excessive brightness or dimness, the application prohibits the user from moving forward in the modeling creation process. In some embodiments, the application provides a visual indicator (e.g., graying out the forward-moving button) to show that the input is not proper. In some embodiments, the application prompts the user to provide clarification or additional information when the input is deemed unreadable. In some embodiments, the application offers tools, such as suggestions, examples, or templates, to aid users in refining the user's input and overcoming any ambiguity or misunderstanding. For example, the application offers tools and functionalities to assist users in refining and enhancing the component images, such as cropping, resizing, or adjusting image properties (e.g., brightness, contrast).

FIG. 4C is a screenshot of the image generation engine 400 of FIG. 4A illustrating using image recognition to translate the picture of FIG. 4A into a digital format. Once uploaded, the digital model generation platform analyze and interpret the component images, extracting relevant features and information that inform the generation of the modeling creation. This process ensures that the digital representation of the modeling creation accurately reflects the physical components used by the user, enhancing the authenticity and realism of the creative output. A user is enabled to revise the available colors from those detected using the mobile app interface.

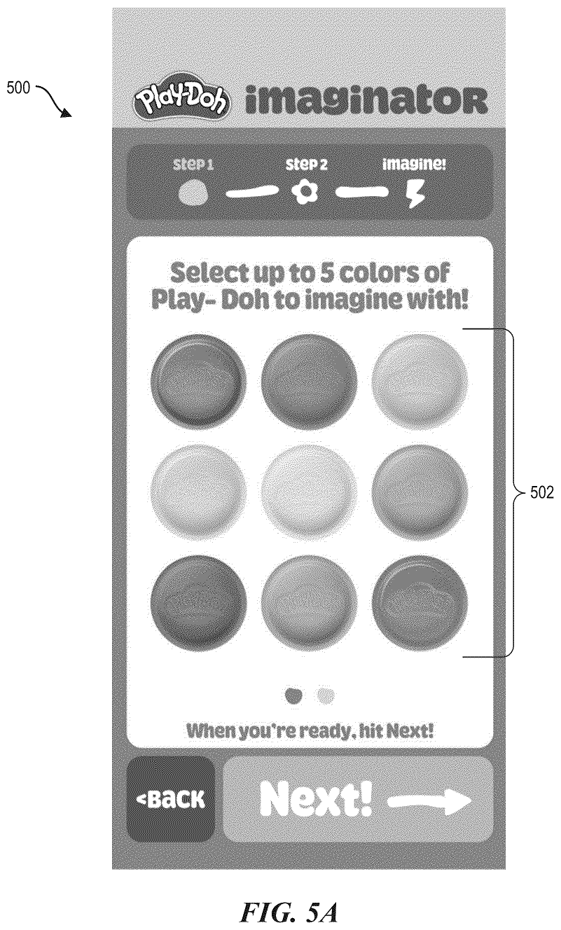

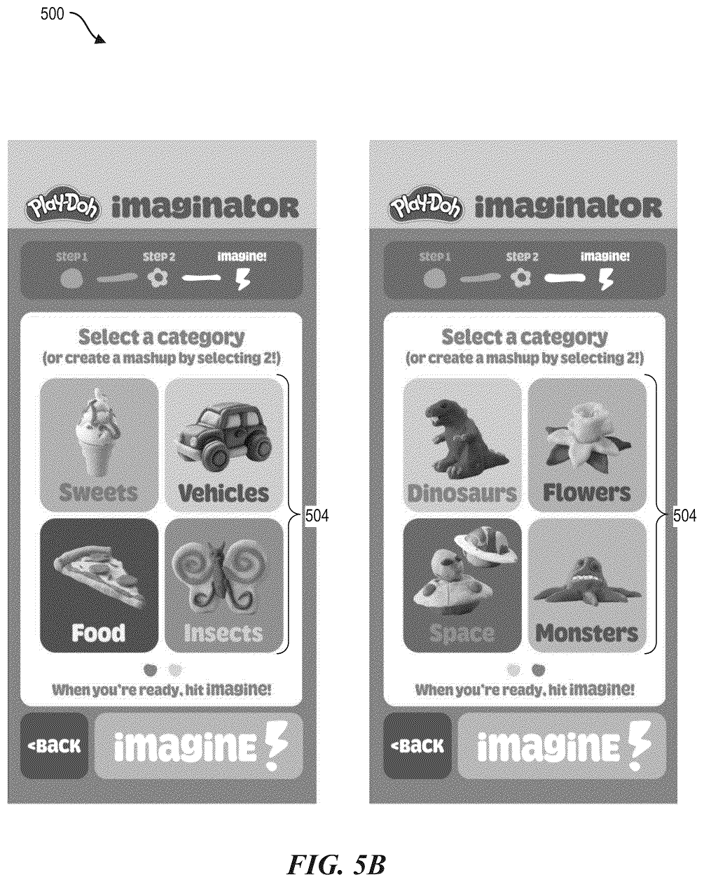

FIG. 5A is a screenshot of an example mobile application 500 illustrating the digital model generation platform presenting components needed for a modeling creation in a digital format for manual selection. Where Figure series 4 enabled a user to dictate materials available via image capture, FIG. 5A enables the user to dictate materials by touchscreen. In some embodiments, the product display interface as described in FIGS. 1A-1B and 2A-2B is accessible on a mobile application. In some embodiments, within the mobile application, users are presented with a set of digital representations of the components needed for modeling creations. For example, the components include various colors of modeling clay, sculpting tools, embellishments, and/or other crafting materials. Each component, in some embodiments, is accompanied by a visual representation of the component, which allows users to more easily understand the referenced component.

The interface of the mobile application enables users to manually select the components the user wishes to utilize in the user's modeling creations. In some embodiments, through touch-based interactions (e.g., tapping, swiping), users navigate through the digital catalog of materials, explore different options, and add selected components to the virtual workspace. The manual selection process provides users with a hands-on approach to curating the materials needed for the user's projects.

In some embodiments, users receive real-time recommendations or suggestions based on the user's preferences. The application uses one or more machine learning models to build user profiles and model individual preferences, either on a per-session basis or overall basis (e.g., throughout multiple sessions). In some embodiments, the application uses the machine learning model to analyze user interactions, such as material selections and feedback to infer user preferences and interests. In addition to user-specific data, the application, in some embodiments, considers contextual information such as current trends, popular materials, and project requirements. For example, if a user is browsing materials for a specific project theme or season (e.g., “Halloween”), the recommendation digital model generation platform prioritizes suggestions that align with those themes or trends. In some embodiments, the recommendation digital model generation platform references external data sources, such as social media platforms, product review websites, or industry trend reports.

FIG. 5B is a screenshot of the mobile application 500 of FIG. 5A generating a set of categories for the modeling creation. After available materials are determined, the user is presented with an interface such as FIG. 5B, which provides a selection of broader thematic concepts and ideas (similar to the manner in which such concepts are presented on a retail display such as depicted in FIG. 1A). The mobile application curates a set of categories (e.g., sweets, vehicles, food, insects, dinosaurs, flowers, space, monsters). In some embodiments, the categories are predetermined. In some embodiments, by leveraging a generative AI model, the application dynamically generates and presents a set of categories based on inferred user preferences. In some embodiments the categories are requested or are selected from trending requests. Similarly to FIG. 5A, the user preferences are inferred from an external database containing contextual information such as current trends or popular materials. In some embodiments, each category is divided into swipeable pages on the user interface of the mobile application. The design prevents overwhelming users with a single, extensive list of categories. The subsequent output (e.g., from the third step illustrated in the screenshots) is similar to that of the end-cap display such as that depicted in FIG. 1B.

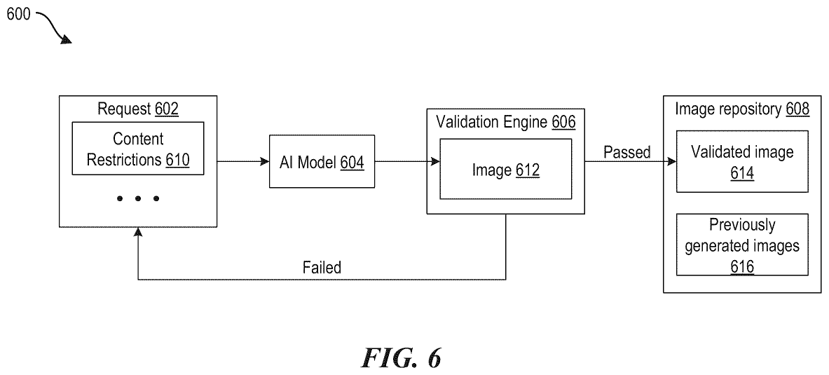

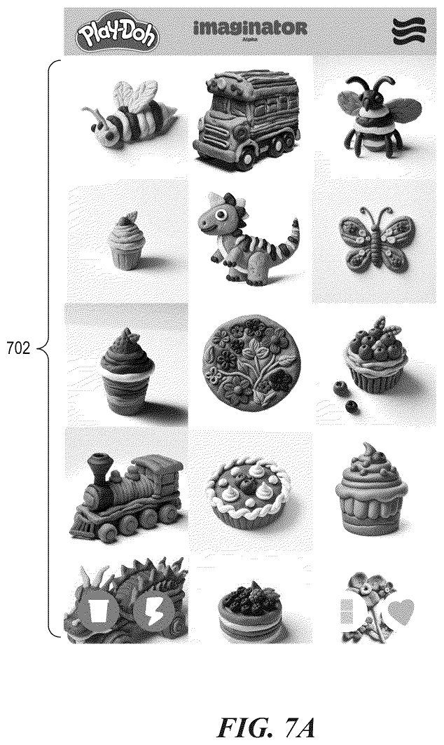

FIG. 6 is a block diagram illustrating an example environment 600 of an image generation engine of the digital model generation platform used to populate an image repository with images of modelling creations. The environment 600 includes a request, an AI model 604, a validation engine 606 (e.g., the validation engine 202 in FIG. 2), and an image repository 608. The request 602 includes content restrictions 610. The validation engine 606 includes image 612 and is implemented using components of the example computer system 1600 illustrated and described in more detail with reference to FIG. 16. The image repository includes a validated image 614 and previously generated images. In some embodiments, implementations of the environment 600 include different and/or additional components or are connected in different ways.

The request 602 contains content restrictions 610 that define parameters and constraints for the generated images (e.g., query context 210, user instructions 212, digital image 218, and so forth with reference to FIG. 2). The content restrictions 610 specify requirements such as ensuring the images appear to be made of modeling materials (e.g., Play-Doh), maintaining age-appropriate content, adhering to specific style guidelines, and so forth. The AI model 604 generates candidate images based on the request parameters of the request 602. The AI model 604 processes inputs such as the content restrictions 610 to produce images that align with the request 602. In some embodiments, the AI model 604 is trained on datasets of modeling creations to ensure generated outputs maintain characteristics consistent with physical modeling materials (e.g., rounded edges). Further discussion of the AI model 604 is below with reference to FIG. 10.

The validation engine 606 is the same as or similar to validation engine 202 discussed with reference to FIG. 2. The validation engine 606 tests the image 612 through validation checks before being approved to be stored in the image repository 608. The image repository 608 operates as a centralized storage for approved images, containing both newly validated images 614 and previously generated images 616. The image repository 608 maintains metadata about stored images (i.e., newly validated images 614 and previously generated images 616) to organize the images based on various attributes such as style, content type, creation date, and so forth.

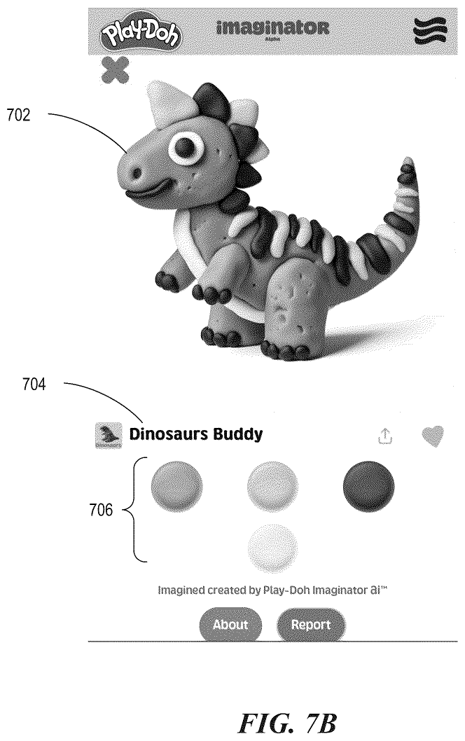

FIGS. 7A and 7B are screenshots illustrating example environments of the image repository 608 of FIG. 6. FIG. 7A includes a plurality of entries 702, where each entry represents a distinct modeling creation that has been validated and stored within the image repository 608. In some embodiments, the entries 702 are organized in a grid layout to enable efficient browsing and selection of stored modeling creations.

The image repository 608 implements a database structure, and each entry 702 includes metadata including creation date, associated categories, creation type, theme, modeling materials used, validation date, and so forth. The image repository 608 indexes the entries 702 based on one or more attributes of the metadata. In some embodiments, the entries 702 are displayed using a responsive interface that adapts to different screen sizes and viewing contexts. Each entry presents a thumbnail preview of the validated model image along with identifying information of the entry (e.g., a picture, a name, and so forth). The interface supports user interactions including selection, filtering, and sorting of entries to help users locate specific modeling creations.

FIG. 7B is a screenshot illustrating an example entry 702 of the image repository 608 of FIG. 6. The example entry 702 is supplemented with a descriptor 704, modeling material indicators 706, and so forth. The descriptor 704 provides textual information about the modeling creation, such as the model's name and category classification. For example, the descriptor 704 identifies, in FIG. 7B, the creation as “Dinosaurs Buddy” and categorizes the creation under the “Dinosaurs” theme, thus providing users with immediate context about the stored creation. Subsequent searches for entries under the “Dinosaurs” theme would then yield the creation “Dinosaurs Buddy.”

The modeling material indicators 706 provide visual and textual cues about the specific modeling materials used in the creation. The indicators help users identify the types and colors of modeling materials required to recreate the stored model. The modeling material indicators 706 are determined, in some embodiments, based on the user instructions 212 within the request 204 of FIG. 2.

In some embodiments, the entry 702 includes additional metadata such as reporting options. For example, in FIG. 7B, the interface displays options for users to report or provide feedback on the stored creation. In some embodiments, The image repository 608 tracks changes made to the entry 702. When modifications are made to an entry's 702 content or metadata, the digital model generation platform maintains a history of changes while preserving the original validated content to maintain data integrity and enable tracking of content evolution over time.

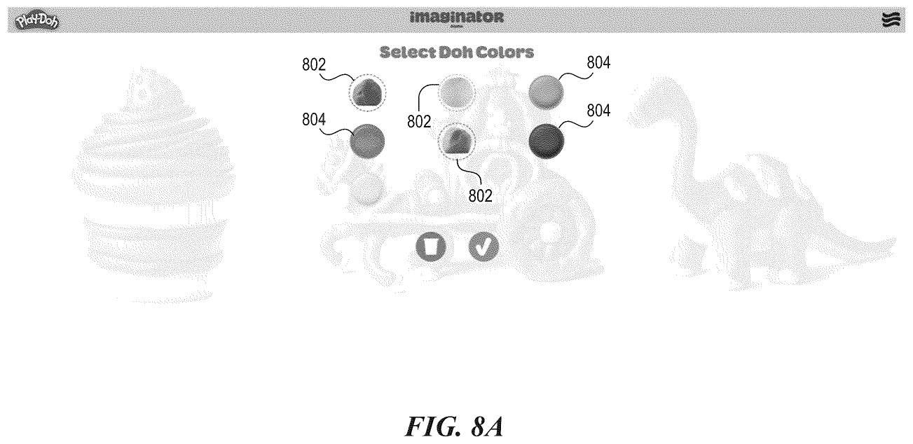

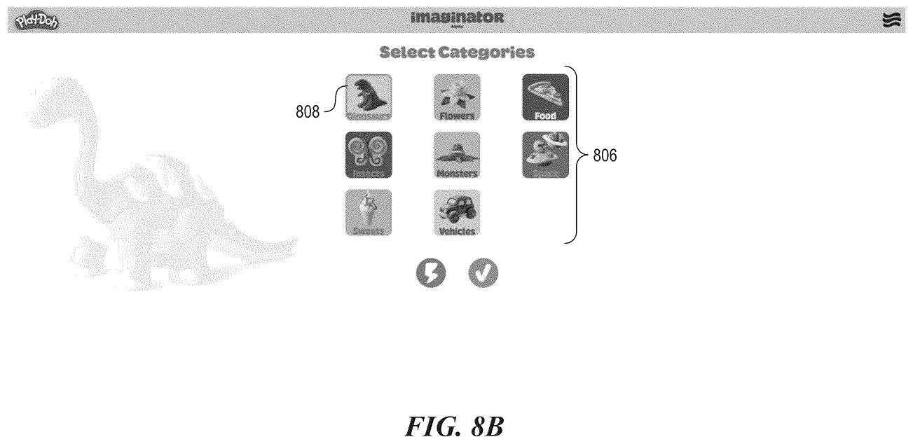

FIG. 8A is a screenshot illustrating an example set of color filters of the image repository of FIG. 6. FIG. 8A displays an interface for color-based filtering that allows users to refine repository content based on modeling material colors. The interface presents a set of color filters including selected colors 802 that are actively filtering the repository content and non-selected colors 804 that represent available but inactive filter options. The digital model generation platform enables users to toggle between selected colors 802 and non-selected colors 804. In some embodiments, the selected colors 802 are visually distinguished to indicate their active status, while the non-selected colors 804 remain available for additional filtering. The digital model generation platform uses the color selections to dynamically update the displayed repository content, showing only entries that contain the selected color combinations. The digital model generation platform maintains color metadata tagged to each repository entry (e.g., entry 702 in FIG. 7) to enable the filtering without real-time image analysis.

FIG. 8B is a screenshot illustrating an example set of categorical filters 806 of the image repository of FIG. 6. The user can select one or more selected categories 808 out of the set of categorical filters 806. The interface enables users to select one or more selected categories 808 from the available categorical filters 806, such as “Dinosaurs,” “Flowers,” “Food,” “Insects,” “Monsters,” and “Space.” The categories correspond to predefined themes and creation types. In some embodiments, users can combine multiple selected categories 808 to narrow down repository content based on specific combinations of themes and attributes. The digital model generation platform processes the selections using metadata tags associated with each repository entry to filter and display relevant content.

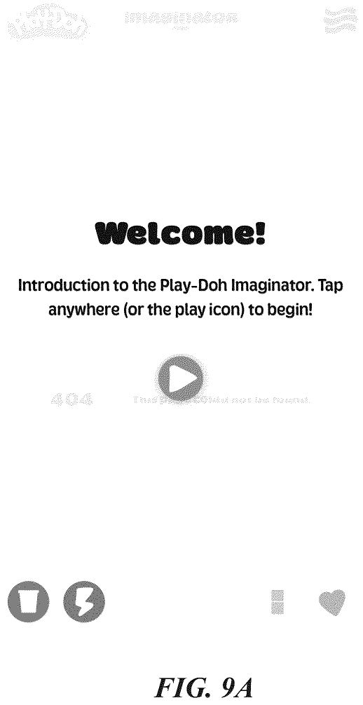

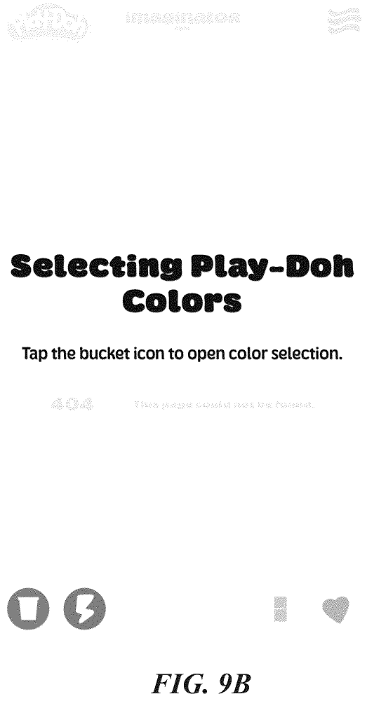

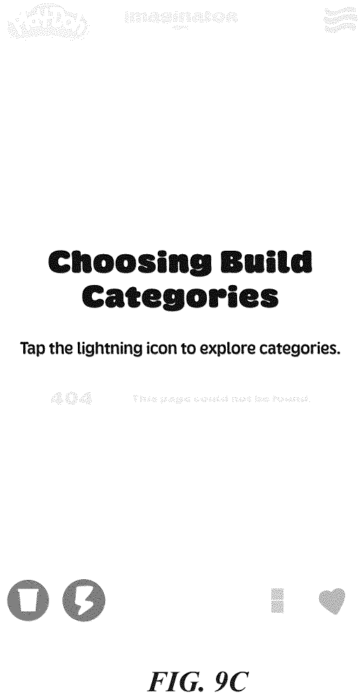

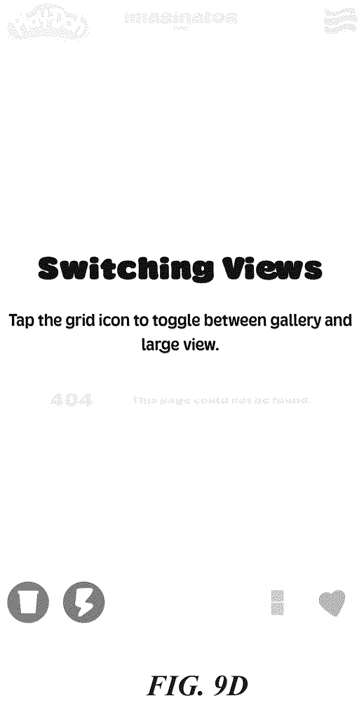

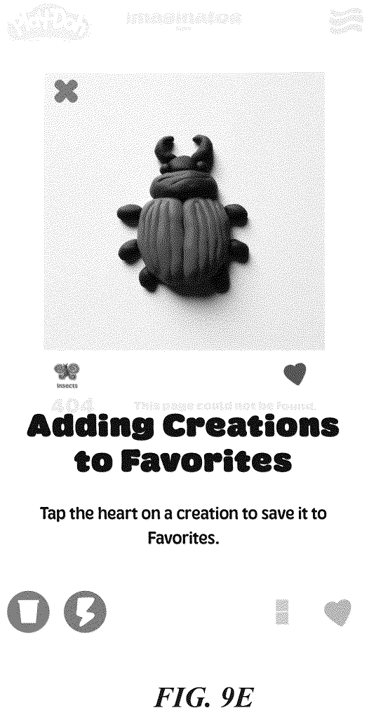

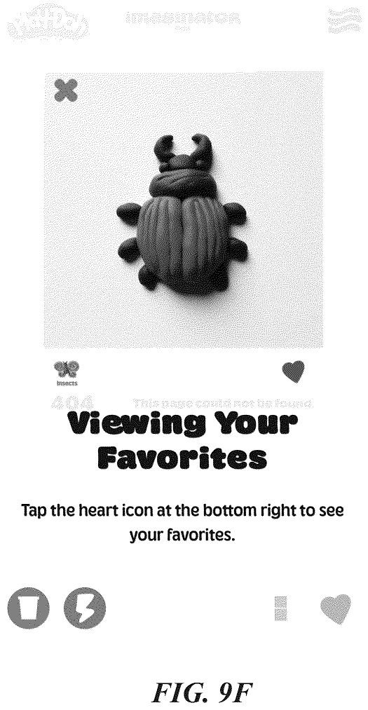

FIGS. 9A-9F are screenshots illustrating example instruction screens including instructions to view images of modelling creations in the image repository of FIG. 6. FIG. 9A displays the initial welcome screen that introduces users to the digital model generation platform. In some implementations, the interface includes progress indicators and navigation controls that allow users to move freely between instruction screens. In FIG. 9A, the interface presents an introductory message explaining the platform's purpose and invites users to begin by tapping anywhere on the screen or selecting a play icon. The initial screen, in some embodiments, implements touch-based interaction via a touch screen communicatively connected to the interface.

FIG. 9B presents instructions for selecting Play-Doh colors within the interface. The screen explains how users are enabled to access the color selection functionality by tapping a bucket icon. The color selection corresponds with the color filters described in FIG. 8A, allowing users to specify their available modeling materials through the visual interface. Similarly, FIG. 9C provides guidance on accessing and utilizing the build categories feature. The screen instructs users to tap a lightning icon to explore available categories for their creations. The categorical selection corresponds to the categorical filters described in FIG. 8B, enabling users to browse and select from predefined themes such as monsters, space explorers, and underwater worlds.

FIG. 9D introduces users to the view switching functionality within the interface. The screen explains how users are enabled to toggle between different view modes by tapping a grid icon. Thus, the digital model generation platform is enabled to accommodate different viewing preferences and adjust content presentation based on user needs.

FIG. 9E demonstrates the favorites functionality, demonstrating to users how to save preferred creations (of a particular session or across multiple sessions) by tapping an icon (e.g., a heart icon) displayed on individual entries. The digital model generation platform adds an indicator of whether an entry is a “favorite” in the metadata of the entries in the image repository to track and retrieve the favorites at a subsequent time. FIG. 9F demonstrates to users how to access their saved favorites through a dedicated heart icon located at the bottom right of the interface. The favorites view depicted in FIG. 9F implements filtered queries to the image repository 608, displaying only content that users have specifically marked as favorites. The digital model generation platform maintains separate favorite collections for each user.

FIG. 10 is a flowchart illustrating a process of using the digital model generation platform to populate an image repository with images of modelling creations. In operation 1002, the digital model generation platform provides an image repository structured based on a plurality of clay model features (e.g., color, subject, theme, user-requested categories, and so forth). For example, the digital model generation platform tags a blue dinosaur model with metadata for both the color attribute “blue” and the theme attribute “dinosaur,” which enables users to later locate the model by searching for either blue creations or dinosaur-themed models. In some implementations, the image repository uses tree-type data structures (e.g., B-tree) to retrieve images based on feature combinations. For instance, if a user searches for “blue dinosaur models suitable for beginners”, the digital model generation platform traverses the index to find matching entries by combining color, theme, and complexity level filters. Each stored image maintains metadata tags such as “color: blue”, “theme: dinosaur”, “complexity: beginner.” The digital model generation platform implements data validation rules—for example, ensuring every stored image has at least one color tag and one theme tag—to maintain consistent categorization.

In operation 1004, the digital model generation platform obtains a set of requests to generate images depicting clay-based models, where each request specifies a different combination of clay model features. For example, when a user requests “generate a blue space alien”, the digital model generation platform creates a request object containing feature parameters like “color: “blue”, theme: “space”, subtype: “alien”. In some implementations, the digital model generation platform prioritizes requests using factors such as complexity and system load. For instance, simple single-color models are processed before complex multi-color designs during high-traffic periods. In some embodiments, when processing a request, for example, for a “red and blue superhero”, the digital model generation platform verifies that both “red” and “blue” are valid color options in the available physical moldable materials or digital options, and that “superhero” exists as an available theme category. In some embodiments, the digital model generation platform tracks patterns in the set of requests—for instance, noting that “dinosaurs” and “space” are commonly combined themes, and thus generating new requests to generate more images satisfying those frequent combinations specifically.

In operation 1006, the digital model generation platform causes a first AI model to generate one or more candidate images depicting the clay-based model based on a corresponding combination of clay model features of the request. For example, the first AI model receives a set of query context that directs the first AI model to generate images realizable using the set of tangible molding products. The set of tangible molding products are, for example, queried from a database communicatively connected to the image generator application. The digital model generation platform translates feature combinations into a command set to operate as an input in the AI model. For example, when generating a “blue space alien”, the digital model generation platform constructs a prompt like “generate a 3D model of a modeling clay creation of an alien inspired by space themes using only blue modeling clay”. In some embodiments, the first AI model queries a connected product database to verify material availability before generation. For instance, if a user requests a model requiring red, blue, and yellow clay, the digital model generation platform first confirms these colors are available in the current product inventory.

In operation 1008, the digital model generation platform determines, using a second AI model (the same model as the first AI model or a different AI model), a degree of compliance of the one or more candidate images with a set of predetermined content restrictions corresponding to a set of tangible molding products used to construct the modeling creation. For example, when validating a generated “space alien” image, the digital model generation platform checks that the model appears to be made of clay (material authenticity), contains no inappropriate features (age-appropriateness), and can be physically constructed with available materials (constructability). In some embodiments, the degree of compliance is determined using a human verification agent (e.g., an administrator).

In some embodiments, the digital model generation platform determines a complexity level of the one or more candidate images to construct a physical model depicting the one or more candidate images, using the set of tangible molding products. The complexity level (e.g., target skill level in FIG. 2) refers to a predefined threshold used by the digital model generation platform to evaluate whether generated model images are appropriately matched to users' modeling abilities. The digital model generation platform determines complexity levels by analyzing visual aspects of the generated images including geometric features, required modeling techniques, estimated construction time, and so forth. The metrics are then compared against predefined skill level targets to ensure the generated models are achievable by users of different ability levels. Evaluating the complexity level enables the digital model generation platform to maintain appropriate difficulty levels for different user groups, such as beginners versus more experienced modelers.

In some embodiments, the digital model generation platform assigns specific numerical scores across multiple dimensions. For instance, a generated model image receives scores for material authenticity (i.e., how closely the texture matches real modeling clay), age-appropriateness (i.e., compliance with age-based content guidelines), constructability (i.e., whether the model can be physically created with available materials), color accuracy (i.e., whether all specified colors are properly represented), and so forth. The digital model generation platform compares these scores against defined thresholds (e.g., requiring 80 or more in all categories) to determine overall compliance.

The digital model generation platform determines, in some embodiments, whether the one or more candidate images depict subjects made of the same material as the set of tangible molding materials such as Play-Doh. The digital model generation platform compares the visual characteristics of generated images against reference datasets containing authentic modeling material appearances. The digital model generation platform uses, for example, CNNs trained on reference datasets containing authentic modeling material appearances. For example, when validating a generated “space alien” image, the digital model generation platform extracts surface textures, material reflectivity, and modeling marks from the model image to ensure they match the characteristic appearance of actual modeling clay.

The digital model generation platform determines, in some embodiments, whether the one or more candidate images incorporate all selected colors of a set of selected colors defined in the combination of clay model features. For instance, if a user selects blue and red clay for their creation, the digital model generation platform detects colors present on the model image to confirm both colors are present in appropriate proportions. In some embodiments, the digital model generation platform accounts for color mixing effects (e.g., combining blue and red to create purple) that might affect color appearance.

The digital model generation platform determines, in some embodiments, whether the one or more candidate images align with a set of age-based content guidelines defined in the combination of clay model features. The digital model generation platform uses one or more AI models to identify potentially unsuitable elements for different age groups. For example, when validating a monster-themed creation, the digital model generation platform verifies that the design maintains an appropriate level of friendliness and avoids scary or inappropriate features for young users. The digital model generation platform uses a set of content guidelines that specify acceptable characteristics for different age ranges, such as shape complexity, thematic elements, visual styling, and so forth. The set of content guidelines can be obtained via, for example, a request by the digital model generation platform to an external application programming interface (API).

The digital model generation platform determines, in some embodiments, whether a size of the clay-based model of the one or more candidate images is compatible with a quantity of the set of tangible molding products. The quantity is defined, for example, in the combination of clay model features (e.g., one container of red Play-Doh and two containers of blue Play-Doh). The digital model generation platform uses the 3D proportions of generated images to calculate the required amount of modeling material. For example, if a user has selected two standard-size containers of molding material, the digital model generation platform ensures the generated model's size and complexity can be achieved with that quantity of material using factors such as material density, required structural support, ratio of the different colors within the image, and so forth.

Responsive to the degree of compliance satisfying a predefined threshold, in operation 1010, the digital model generation platform populates the image repository with the one or more candidate images based on the clay model features of the one or more candidate images. On the other hand, if the digital model generation platform detects that the degree of compliance fails to satisfy the predefined threshold, the digital model generation platform generates, using the first AI model, another different set of candidate images for each request, depicting the new clay-based model based on the corresponding combination of model features. As with the initial set of candidate images, the digital model generation platform determines, using the second AI model, a degree of compliance of the different set of candidate images with the set of predetermined content restrictions corresponding to the set of tangible molding products used to construct the new modeling creation.

In some embodiments, the digital model generation platform causes a third AI model to generate a set of instructions to construct a physical model depicting the one or more candidate images using the set of tangible molding products. The digital model generation platform determines a sequence of modeling steps associated with constructing the physical model in accordance with the corresponding combination of model features, and generates a set of textual descriptions for each modeling step. Further details of generating the set of instructions are discussed with reference to FIG. 15.

The digital model generation platform is, in some embodiments, implemented in a product display (e.g., product display 100 in FIG. 1A) having a touch screen interface. The product display includes, for example, a set of tangible molding materials (such as the product display of FIG. 1). The digital model generation platform presents the one or more candidate images on the interface. If the digital model generation platform receives, via the interface of the image generator application, interaction data indicating user approval of the one or more candidate images, the digital model generation platform populates the image repository with the one or more candidate images based on the model features of the one or more candidate images.

### Example Embodiments of Transforming Images Using the Digital Model Generation Platform (Upscaling)

FIG. 11A is a screenshot of an example mobile application 1100 illustrating an image transformation engine of the digital model generation platform receiving a user picture of a tangible modeling creation. The interface of the application provides options for users to upload or capture images of the user's tangible modeling creations using the user's device's camera or gallery. For example, in FIG. 11A, the user inputs a picture of the tangible creation using the molding components. In some embodiments, users have the option to manually upload pictures of the user's tangible modeling creations from the user's device's gallery or file system. In some embodiments, the application features a real-time capture functionality that enables users to capture images of the user's modeling creations directly within the app interface using the user's device's camera to allow users to integrate the user's creations into the application without the need for external tools or software. In some embodiments, the application is communicatively connected with external platforms or services, such as social media networks or cloud storage providers, to enable users to access and incorporate content from the user's preferred platforms directly within the modeling environment, improving convenience and accessibility.

In some embodiments, within the interface of the application, users are equipped with navigation tools, such as “back” and “next” buttons, to facilitate interaction with the image transformation application. The buttons serve as navigational aids, allowing users to navigate between different screens, options, and settings within the application. The “back” button enables users to backtrack to previous screens or steps, providing flexibility to review or adjust previous selections. Conversely, the “next” button propels users forward in the process, allowing the user to progress to the next stage of customization or refinement.

On the interface of the application, visual indicators show the user's progress through the image transformation process. Steps or stages are displayed on the interface to provide users with a sense of direction and guiding the user through each phase of customization. The steps are checkpoints to enable users to track the user's progress and understand where the user is in the image transformation process. As users navigate through the application, the interface dynamically updates to reflect the user's current step. In some embodiments, the current step is visually indicated (e.g., highlighted) to emphasize the step to the user.

FIG. 11B is a screenshot of the mobile application 1100 of FIG. 11A illustrating selecting user preferences for a digital transformation of the tangible modeling creation. Within the application, users are presented with a range of options and parameters that enable the users to direct various parameters of the generated image, as further described in FIGS. 1A and 1B. In some embodiments, the user interface of the application provides a set of categories for the user to select from (e.g., monsters, space explorers, underwater world). The selected category directs the generative AI model to generate an image incorporating features of the selected category.

In some embodiments, the user interface of the application offers controls and sliders that allow users to adjust parameters such as color intensity, texture detail, shape complexity, and overall style. The parameters enable users to tailor the characteristics of the AI-generated image to align with the user's desired aesthetic or thematic preferences. For example, users choose to enhance the vibrancy of colors, increase the level of detail in textures, or simplify the shapes for a more minimalist look. In some embodiments, the range of parameters is generated by a generative AI model. The generative AI model, in some embodiments, is directed by query context to take into account historical user choices (e.g., displaying “Monsters” as a category because many historical users showed interest in “Monsters”) and configured to dynamically update the parameters based on changing user preferences. In some embodiments, the range within each of the parameters is predefined by the application.

A user takes a picture of a user made creation and causes the digital model generation platform to identify that the image includes a given creative medium (e.g., Play-Doh) and the subject of the medium. Where confidence exceeds a threshold, the digital model generation platform proceeds to upscale the picture. Where confidence is below the threshold issue, the platform issues guiding questions to request some help in an encouraging way such as asking what sort of setting (e.g., physical place such as space, the ocean, a jungle, etc.) or a character category (e.g., monsters, animals, superheroes, aliens, etc.) the child's creation belongs in to improve confidence of given AI related guesses. Rather than make incorrect assumptions about what the creation is (which might be upsetting to a child) the digital model generation platform guides the user to explain their creation first (thereby encouraging the child's artistic efforts) in a way that improves the AI confidence. Once the AI reaches a predetermined confidence threshold on what the creation is, the digital model generation platform initiates an upscaling image of the creation (as depicted in FIG. 11C).

FIG. 11C is a screenshot of the mobile application 1100 of FIG. 11A illustrating the digital model generation platform generating the digital transformation of the tangible modeling creation using a generative artificial intelligence (AI) model. The application directs a generative AI model to interpret the user's preferences, input, and selected parameters to generate a digital representation of the user's image input that encapsulates the essence of the envisioned modeling creation. In the depicted example, the original creation is upscaled based on the “monster” category. The generative AI model applies prompt engineering to dictate the end result. An example command set is to “generate a 3D model of a modelling clay creation of a monster inspired by an attached image and using the colors of modelling clay present in the attached image.”

In some embodiments, the digital representation appears to be made of the same molding material used in the user picture. In some embodiments, the digital representation appears more abstract (e.g., smoother, more digital-looking) and not made of the molding material that the tangible molding creation is made of.

The AI model uses, in some embodiments, deep learning to transform the user-input image. Deep learning transforms images by changing the image's style through techniques such as style transfer. The technique leverages CNNs to extract and manipulate the style and content features of images separately. During style transfer, the model first separates the style and content representations of a pair of input images: one serving as the style reference and the other as the content reference. The style reference image provides the desired artistic style (e.g., cartoonish, realistic), while the content reference image supplies the underlying structure and content of the scene (e.g., the tangible molded creation). The model then applies the style of the style reference image to the content of the content reference image, effectively transferring the artistic characteristics while preserving the structural details of the original scene. For example, if the tangible molded creation has eight protruding limbs and the category is “Under the Sea,” the AI model infers that the creation is an octopus. The process involves optimizing the image to minimize the difference between its content features and those of the content reference image, while simultaneously matching the generated image's style features to those of the style reference image.

In some embodiments, the deep learning models produce diverse variations of images. The model generates a wide range of images, including new outputs that do not exist in the original training dataset. For example, the same input picture (such as that of FIG. 11A) will not always return the same output (such as that of FIG. 11C). In some embodiments, only images made with materials available to the user are generated, as further described in FIG. 1B.

The application receives a confidence score from the generative AI model for each output. In some embodiments, the generative AI model uses factors such as input data, model parameters, and training data distribution, to estimate the likelihood that the generated output accurately reflects the user's intent or preferences. Upon generating an output, the AI system computes a confidence score that quantifies the level of certainty associated with the output. This score serves as a quantitative measure of the digital model generation platform's confidence in the accuracy and reliability of the generated content. For example, if the confidence score exceeds a predefined threshold (e.g., 70%), the digital model generation platform proceeds to present the output to the user without further intervention. Conversely, if the confidence score falls below the threshold, indicating a lower degree of confidence in the accuracy of the output, the digital model generation platform prompts the user for additional input or clarification (e.g., displaying “What do you see in this picture?”). In some embodiments, the digital model generation platform engages in an iterative dialogue with the user to gather additional context or constraints that enhance the accuracy and relevance of the generated content.

FIG. 11D is a screenshot of the mobile application 1100 of FIG. 11A illustrating user customization on a user interface of the digital model generation platform of FIGS. 2A and 2B related to the digital transformation of the tangible modeling creation. In some embodiments, the application includes customization options for the generated image. For example, the application allows users to name the user's image creations (e.g., naming the creation “Squibbles”). In some embodiments, the application autonomously generates names that are descriptive and tailored to the characteristics of the image creation using a generative AI model. In some embodiments, users have the flexibility to choose between user-provided and AI-generated names, providing the user with a range of options to personalize the user's creative outputs according to the user's preferences. In some embodiments, the name category is pre-defined by the application. Additionally, in some embodiments, the color palette of the output image displayed in the interface is dynamically generated based on the colors present in the image of the modeling creation (e.g., blue and red are shown as the color palette because those are the colors used in the image). The digital model generation platform analyzes the image to extract color information, which is then used to populate the palette with relevant color choices. In some embodiments, a counter tracks the number of creations in the session. Each time a new image creation is generated, the counter is updated in real-time (e.g., FIG. 11D is creation number eight).

FIG. 11E is a screenshot of the mobile application 1100 of FIG. 11A illustrating a customized digital profile of the digital transformation of the tangible modeling creation. In some embodiments, the image transformation application showcases a backstory for the generated modeling creation. In some embodiments, the backstory is generated by a generative AI model. In some embodiments, the application provides the generative AI model with query context so that the generative AI model is able to dynamically adjust the generative AI mode's output to include relevant details, features, or attributes related to the molding product, thereby ensuring that the generated content more closely connects with the user's creative process. For instance, if the user selects a specific molding product or material type (e.g., Play-Doh), the AI model generates modeling creation backstories that incorporate elements or characteristics specific to that product, such as texture, shape, or functionality (e.g., “In his early days, Squibbles was just a lump of blue Play-Doh until a child's laughter sparked him to life.”).

In some embodiments, the backstory is pre-generated by the application. Additionally, the customized profile, in some embodiments, allows users to input or edit the backstory of the input's modeling creation, fostering a collaborative and participatory experience. Through text input interfaces, users refine, expand, and/or personalize the narrative according to the user's preferences and creative vision.

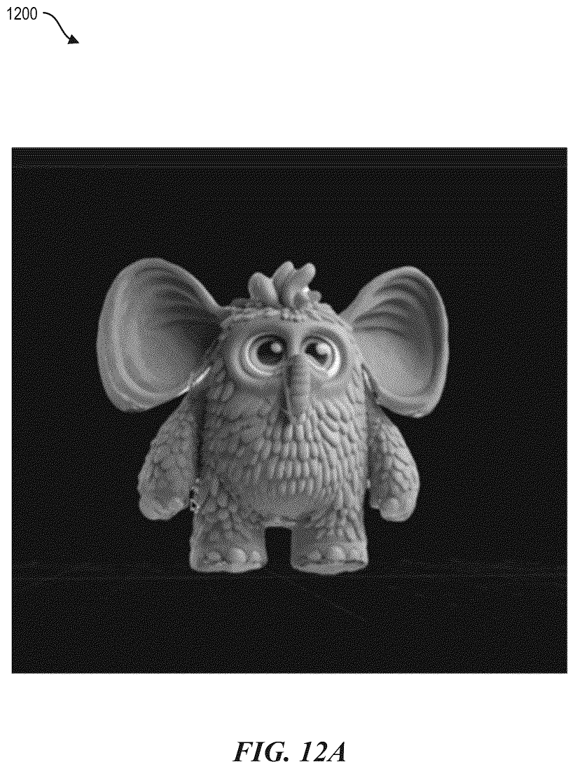

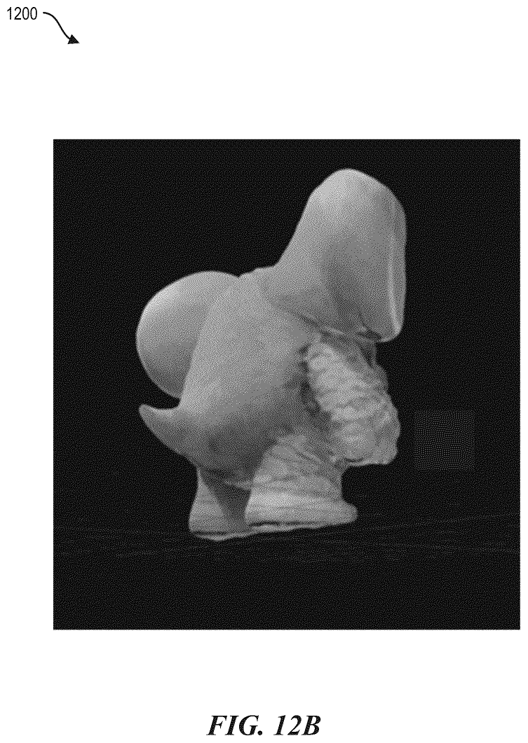

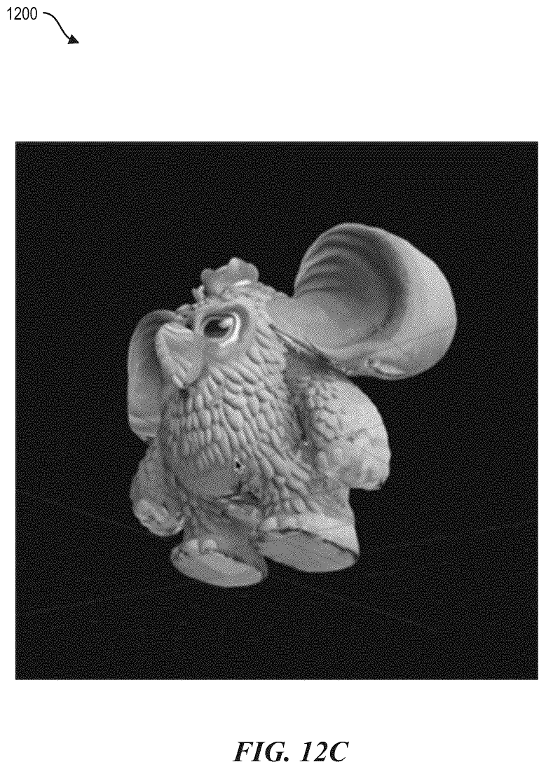

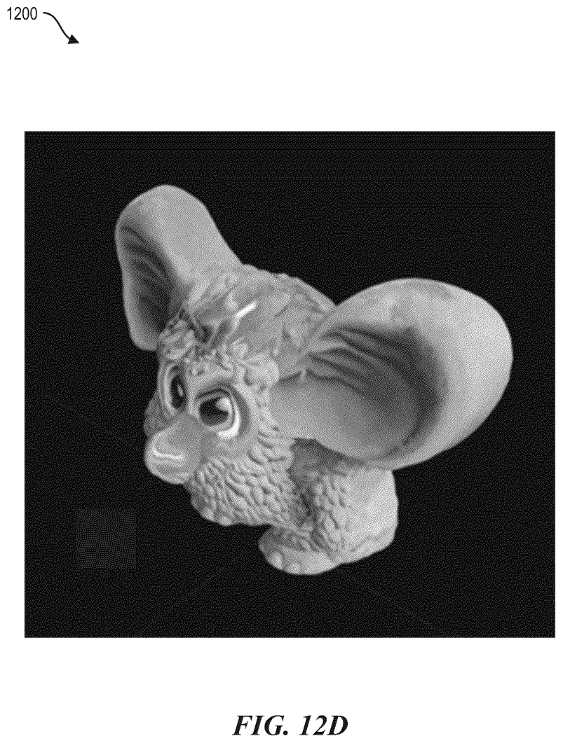

FIG. 12A is a screenshot illustrating one embodiment of a front view of a suggested modeling creation 1200 in an Standard Triangle Language (STL) file for 3D printing. FIG. 12B is a screenshot illustrating one embodiment of a back view of the suggested modeling creation 1200 of FIG. 12A in an STL file compatible for 3D printing. FIG. 12C is a screenshot illustrating one embodiment of a bottom view of the suggested modeling creation 1200 of FIG. 12A in an STL file compatible for 3D printing. FIG. 12D is a screenshot illustrating one embodiment of a top view of the suggested modeling creation 1200 of FIG. 12A in an STL file compatible for 3D printing. In some embodiments, the printout or email of the product display in FIGS. 5A-5E includes a 3D model representation of the suggested modeling creation image. The application generates a 3D printer file in a standard format such as STL (stereolithography) or OBJ (object), as shown in FIGS. 6A-6D. The file contains the geometric data necessary to recreate the upscaled 3D model using a 3D printer. In some embodiments, the 3D model is animated by the AI in an image or video format (e.g., .gif, .mpeg, .mp4, etc.).

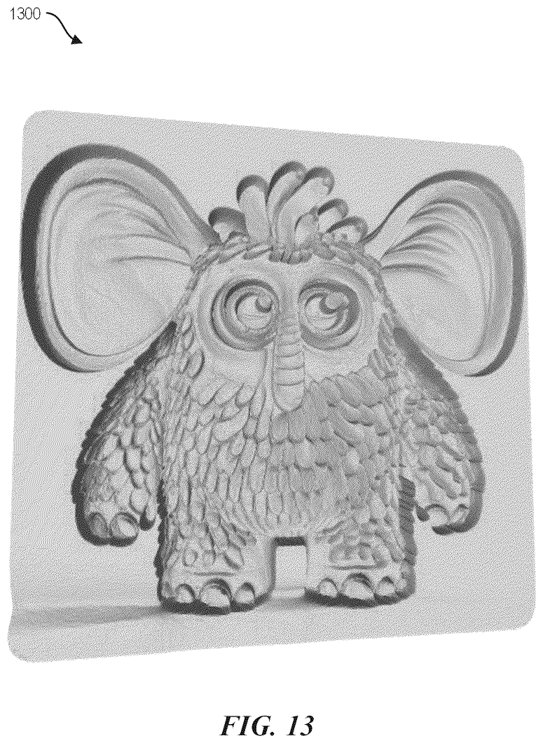

FIG. 13 is an image illustrating one embodiment of a 3D-printed mold 1300 of the suggested modeling creation of FIG. 12A printed from an STL file. The 3D printer-compatible file is printed or emailed to the user, who is able to then use the 3D file to print the 3D mold at a future time with a 3D printer. In some embodiments, when a user selects the option to print or email the user's upscaled 3D model, the application communicates with the product display's built-in 3D printer functionality. The application outputs the generated 3D printer file for user consumption (e.g., by 3D printing apparatus). In some embodiments of the end cap display 100, the onboard printer 106 is a 3D printer and the end cap display generates a physical copy of the 3D printed mold 1300. In a given example, the 3D printer subsystem interprets the received printer file and translates it into instructions for the printer hardware. Utilizing manufacturing principles such as fused deposition modeling (FDM) or stereolithography (SLA), the printer gradually builds up layers of material to recreate the upscaled 3D model in physical form. Once the printing process is complete, users retrieve the user's fabricated 3D model directly from the end cap display, bringing the user's digital creations into a tangible format. After obtaining a 3D model, the user, in some embodiments, inserts the molding component into the 3D mold to more easily create the suggested modeling creation.

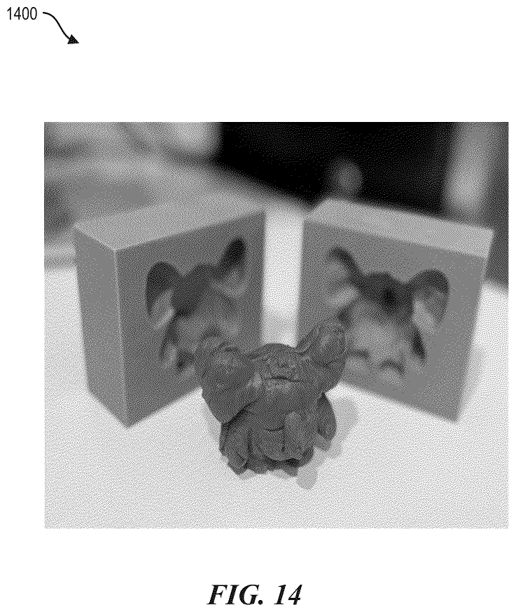

FIG. 14 is an image illustrating one embodiment of a physical representation 1400 of the suggested modeling creation of FIG. 12A constructed using the 3D-printed mold 1300 of FIG. 13. The physical representation 1400 is created by inserting modeling materials into the 3D-printed mold 1300, which provides structural guidance for shaping the materials according to the validated model design. The 3D-printed mold's 1300 geometry, derived from the STL file, ensures accurate reproduction of the suggested model's features and proportions.

The user is enabled to use the modeling material indicators provided by the digital model generation platform to select appropriate colors and materials for constructing the physical representation. The indicators help users accurately match the materials needed to recreate the suggested model's appearance as shown in the validated model image. The physical representation 1400 demonstrates how the digital-to-physical workflow enables users to transform AI-generated suggestions into tangible creations. The use of the 3D-printed mold 1300 enables consistent reproduction of complex shapes and features that are challenging to achieve through freehand modeling, especially to a less experienced user.

FIG. 15 is a flowchart illustrating a process of using the image transformation engine of the digital model generation platform to generate digital representations of modelling creations. In operation 1502, the digital model generation platform receives (1) an image depicting a tangible clay-based model associated with a plurality of clay model features and (2) a selection of clay model features (e.g., color, subject, theme, user-requested categories, and so forth). The digital model generation platform extracts visual characteristics including shape, texture, color information, and so forth. The selection of model features includes attributes such as color preferences, thematic categories, and custom parameters.

In operation 1504, the digital model generation platform causes a first AI model to generate one or more candidate digital representations depicting the tangible clay-based model based on the selection of model features. The first AI model generates the one or more candidate digital representations based on a pattern of the tangible modeling creation, a shape of the tangible modeling creation, a texture of the tangible modeling creation, a color of the tangible modeling creation, and so forth. In some embodiments, the digital model generation platform maintains a set of mapping rules for each category to ensure consistent feature translation from images of physical models to digital representations. For example, in the “Dinosaurs” category, the digital model generation platform maps specific components such as head shape, tail length, and limb positioning from the input image to corresponding features in the digital output. Similarly, for the “Space” category, the digital model generation platform identifies and maps elements like antenna, multiple eyes, or unique appendages that are characteristic of alien creatures.

In operation 1506, the digital model generation platform determines, using a second AI model (which is the same as or different from the first AI model), a degree of compliance of the one or more candidate digital representations with a set of predetermined content restrictions corresponding to a set of tangible molding products used to construct the tangible modeling creation. Methods of determining compliance are discussed with further reference to the validation checks of FIG. 2.

Responsive to the degree of compliance satisfying a predefined threshold, in operation 1508, the digital model generation platform presents the one or more candidate digital representations on a user interface. In some embodiments, the digital model generation platform generates a three-dimensional (3D) model of at least one of the candidate digital representations that maintain accurate geometric structure, proper scale and proportions, required support structures, and is in a format compatible with 3D printing. The 3D models enable users to create physical molds for recreating the transformed designs through 3D printing technology.

The digital model generation platform generates, using a third AI model (which is the same as or different from the first and second AI model), a set of story elements for at least one of the one or more candidate digital representations based on the selection of model features. The digital model generation platform presents the set of story elements proximate to the one or more candidate digital representations on the user interface. For example, when processing a blue clay creature, the digital model generation platform might generate a story describing “In his early days, Squibbles was just a lump of blue Play-Doh until a child's laughter sparked him to life.” The digital model generation platform presents these generated story elements alongside the digital representations on the user interface to improve the interactive experience with dynamically generated narrative context that aligns with both the visual content and selected model features.

### Example Computing Platform of the Digital Model Generation Platform

FIG. 16 is a block diagram illustrating an example computer system 1600, in accordance with one or more embodiments. In some embodiments, components of the example computer system 1600 are used to implement the software platforms described herein. At least some operations described herein can be implemented on the computer system 1600.

In some embodiments, the computer system 1600 includes one or more central processing units (“processors”) 1602, main memory 1606, non-volatile memory 1610, network adapters 1612 (e.g., network interface), video displays 1618, input/output devices 1620, control devices 1622 (e.g., keyboard and pointing devices), drive units 1624 including a storage medium 1626, and a signal generation device 1620 that are communicatively connected to a bus 1616. The bus 1616 is illustrated as an abstraction that represents one or more physical buses and/or point-to-point connections that are connected by appropriate bridges, adapters, or controllers. The bus 1616, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1694 bus (also referred to as “Firewire”).

In some embodiments, the computer system 1600 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1600.

While the main memory 1606, non-volatile memory 1610, and storage medium 1626 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1628. The term “machine-readable medium” and “storage medium” shall also be taken to include any medium that is capable of storing, encoding, or carrying a set of instructions for execution by the computer system 1600. In some embodiments, the non-volatile memory 1610 or the storage medium 1626 is a non-transitory, computer-readable storage medium storing computer instructions, which is executable by the one or more “processors” 1602 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1604, 1608, 1628) set at various times in various memory and storage devices in a computer device. When read and executed by the one or more processors 1602, the instruction(s) cause the computer system 1600 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1610, floppy and other removable disks, hard disk drives, optical discs (e.g., compact disc read-only memory (CD-ROMS), digital versatile discs (DVDs)), and transmission-type media such as digital and analog communication links.

The network adapter 1612 enables the computer system 1600 to mediate data in a network 1614 with an entity that is external to the computer system 1600 through any communication protocol supported by the computer system 1600 and the external entity. The network adapter 1612 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1612 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between the entities). In some embodiments, the firewall additionally manages and/or has access to an access control list that details permissions, including the access and operation rights of an object by an individual, a machine, and/or an application, and the circumstances under which the permission rights stand.

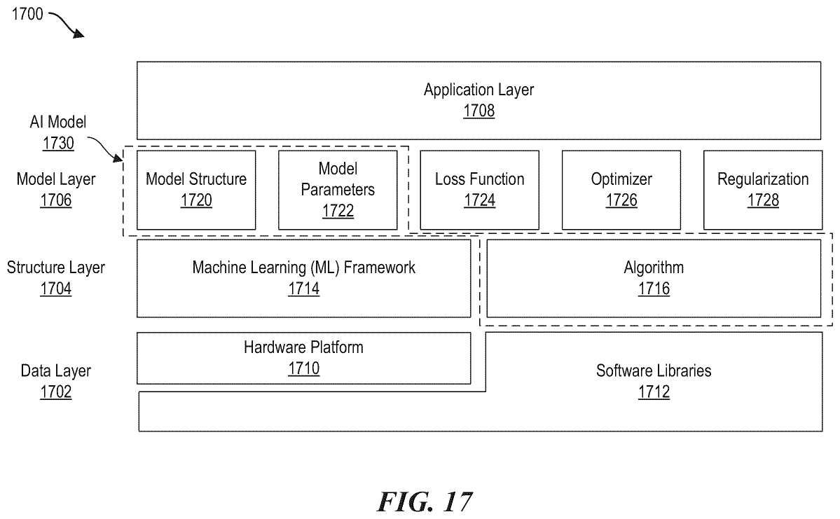

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1700 illustrated and described in more detail with reference to FIG. 17.

### Example AI System of the Digital Model Generation Platform

FIG. 17 is a high-level block diagram illustrating an example AI system, in accordance with one or more embodiments. The AI system 1700 is implemented using components of the example computer system 1600 illustrated and described in more detail with reference to FIG. 16. Likewise, embodiments of the AI system 1700 include different and/or additional components or be connected in different ways.

In some embodiments, as shown in FIG. 17, the AI system 1700 includes a set of layers, which conceptually organize elements within an example network topology for the AI system's architecture to implement a particular AI model 1730. Generally, an AI model 1730 is a computer-executable program implemented by the AI system 1700 that analyses data to make predictions. Information passes through each layer of the AI system 1700 to generate outputs for the AI model 1730. The layers include a data layer 1702, a structure layer 1704, a model layer 1706, and an application layer 1708. The algorithm 1716 of the structure layer 1704 and the model structure 1720 and model parameters 1722 of the model layer 1706 together form the example AI model 1730. The optimizer 1726, loss function engine 1724, and regularization engine 1728 work to refine and optimize the AI model 1730, and the data layer 1702 provides resources and support for the application of the AI model 1730 by the application layer 1708.

The data layer 1702 acts as the foundation of the AI system 1700 by preparing data for the AI model 1730. As shown, in some embodiments, the data layer 1702 includes two sub-layers: a hardware platform 1710 and one or more software libraries 1712. The hardware platform 1710 is designed to perform operations for the AI model 1730 and includes computing resources for storage, memory, logic, and networking. The hardware platform 1710 processes amounts of data using one or more servers. The servers can perform backend operations such as matrix calculations, parallel calculations, machine learning (ML) training, and the like. Examples of servers used by the hardware platform 1710 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1710 includes Infrastructure as a Service (IaaS) resources, which are computing resources, (e.g., servers, memory, etc.) offered by a cloud services provider. In some embodiments, the hardware platform 1710 includes computer memory for storing data about the AI model 1730, application of the AI model 1730, and training data for the AI model 1730. In some embodiments, the computer memory is a form of random-access memory (RAM), such as dynamic RAM, static RAM, and non-volatile RAM.

In some embodiments, the software libraries 1712 are thought of as suites of data and programming code, including executables, used to control the computing resources of the hardware platform 1710. In some embodiments, the programming code includes low-level primitives (e.g., fundamental language elements) that form the foundation of one or more low-level programming languages, such that servers of the hardware platform 1710 can use the low-level primitives to carry out specific operations. The low-level programming languages do not require much, if any, abstraction from a computing resource's instruction set architecture, allowing them to run quickly with a small memory footprint. Examples of software libraries 1712 that can be included in the AI system 1700 include Intel Math Kernel Library, Nvidia cuDNN, Eigen, and Open BLAS.

In some embodiments, the structure layer 1704 includes an ML framework 1714 and an algorithm 1716. The ML framework 1714 can be thought of as an interface, library, or tool that allows users to build and deploy the AI model 1780. In some embodiments, the ML framework 1714 includes an open-source library, an application programming interface (API), a gradient-boosting library, an ensemble method, and/or a deep learning toolkit that works with the layers of the AI system facilitate development of the AI model 1730. For example, the ML framework 1714 distributes processes for the application or training of the AI model 1730 across multiple resources in the hardware platform 1710. In some embodiments, the ML framework 1714 also includes a set of pre-built components that have the functionality to implement and train the AI model 1730 and allow users to use pre-built functions and classes to construct and train the AI model 1730. Thus, the ML framework 1714 can be used to facilitate data engineering, development, hyperparameter tuning, testing, and training for the AI model 1730. Examples of ML frameworks 1714 that can be used in the AI system 1700 include TensorFlow, PyTorch, Scikit-Learn, Keras, Caffe, LightGBM, Random Forest, and Amazon Web Services.

In some embodiments, the algorithm 1716 is an organized set of computer-executable operations used to generate output data from a set of input data and can be described using pseudocode. In some embodiments, the algorithm 1716 includes code that allows the computing resources to learn from new input data and create new/modified outputs based on what was learned. In some implementations, the algorithm 1716 builds the AI model 1730 through being trained while running computing resources of the hardware platform 1710. The training allows the algorithm 1716 to make predictions or decisions without being explicitly programmed to do so. Once trained, the algorithm 1716 runs at the computing resources as part of the AI model 1730 to make predictions or decisions, improve computing resource performance, or perform tasks. The algorithm 1716 is trained using supervised learning, unsupervised learning, semi-supervised learning, and/or reinforcement learning.

The application layer 1708 describes how the AI system 1700 is used to solve problems or perform tasks. In an example implementation, the application layer 1708 includes the product display application.

As an example, to train an AI model 1730 that is intended to model human language (also referred to as a language model), the data layer 1702 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1702 is annotated with ground truth labels (e.g., each data entry in the training dataset is paired with a label), or unlabeled.

Training an AI model 1730 generally involves inputting into an AI model 1730 (e.g., an untrained ML model) data layer 1702 to be processed by the AI model 1730, processing the data layer 1702 using the AI model 1730, collecting the output generated by the AI model 1730 (e.g., based on the inputted training data), and comparing the output to a desired set of target values. If the data layer 1702 is labeled, the desired target values, in some embodiments, are, e.g., the ground truth labels of the data layer 1702. If the data layer 1702 is unlabeled, the desired target value is, in some embodiments, a reconstructed (or otherwise processed) version of the corresponding AI model 1730 input (e.g., in the case of an autoencoder), or is a measure of some target observable effect on the environment (e.g., in the case of a reinforcement learning agent). The parameters of the AI model 1730 are updated based on a difference between the generated output value and the desired target value. For example, if the value outputted by the AI model 1730 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1730 typically is to minimize a loss function or maximize a reward function.

In some embodiments, the data layer 1702 is a subset of a larger data set. For example, a data set is split into three mutually exclusive subsets: a training set, a validation (or cross-validation) set, and a testing set. The three subsets of data, in some embodiments, are used sequentially during AI model 1730 training. For example, the training set is first used to train one or more ML models, each AI model 1730, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. The steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1730. Backpropagation is used to adjust (also referred to as update) the value of the parameters in the AI model 1730, with the goal of optimizing the objective function. For example, a defined loss function is calculated by forward propagation of an input to obtain an output of the AI model 1730 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1730 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1730 is sufficiently converged with the desired target value), after which the AI model 1730 is considered to be sufficiently trained. The values of the learned parameters are then fixed and the AI model 1730 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1730 typically involves further training the ML model on a number of data samples (which may be smaller in number/cardinality than those used to train the model initially) that closely target the specific task. For example, an AI model 1730 for generating natural language that has been trained generically on publicly available text corpora is, e.g., fine-tuned by further training using specific training samples. In some embodiments, the specific training samples are used to generate language in a certain style or a certain format. For example, the AI model 1730 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, inputs to an LLM are structured prompt engineering. Prompt engineering is a process of structuring text that is able to be interpreted by a generative AI model. Predefined prompts, in some embodiments, serve as predefined templates or structured queries that already adhere to the expected format and content guidelines of specific AI models. For example, in some embodiments, a prompt (e.g., command set) includes the following elements: instruction, context, input data, and an output specification.

Although a prompt is a natural-language entity, a number of prompt engineering strategies help structure the prompt in a way that improves the quality of output. For example, in the prompt “Please generate an image of a bear on a bicycle for a children's book illustration,” “generate,” is the instruction, “for a children's book illustration” is the context, “bears on a bicycle” is the input data, and “an image” is the output specification. The techniques include being precise, specifying context, specifying output parameters, specifying target knowledge domain, and so forth.

Automatic prompt engineering techniques have the ability to, for example, include using a trained LLM to generate a plurality of candidate prompts, automatically score the candidates, and select the top candidates.

In some embodiments, prompt engineering includes the automation of a target process—for instance, a prompt causes an AI model to generate computer code, call functions in an API, and so forth. Additionally, in some embodiments, prompt engineering includes automation of the prompt engineering process itself—for example, an automatically generated sequence of cascading prompts, in some embodiments, include sequences of prompts that use tokens from AI model outputs as further instructions, context, inputs, or output specifications for downstream AI models. In some embodiments, prompt engineering includes training techniques for LLMs that generate prompts (e.g., chain-of-thought prompting) and improve cost control (e.g., dynamically setting stop sequences to manage the number of automatically generated candidate prompts, dynamically tuning parameters of prompt generation models or downstream models).

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

We claim:

1. A computer-implemented method for automatically populating a structured image repository with images depicting clay-based models using generative artificial intelligence (AI), comprising:
providing an image generator application including an image repository structured based on a plurality of clay model features;
obtaining a set of requests, via the image generator application, to generate images depicting clay-based models, wherein each request specifies a different combination of clay model features;
for each particular request:
causing a first AI model to generate one or more candidate images depicting a particular clay-based model based on a corresponding combination of clay model features of the particular request,
wherein clay model features of the one or more candidate images satisfy the corresponding combination of clay model features;
determining, using a second AI model, a degree of compliance of the one or more candidate images with a set of predetermined content restrictions corresponding to a set of tangible molding products used to construct the particular clay-based model; and
responsive to the degree of compliance satisfying a predefined threshold, populating the image repository with the one or more candidate images based on the clay model features of the one or more candidate images.

2. The computer-implemented method of claim 1, wherein the first AI model and the second AI model are the same generative AI model.

3. The computer-implemented method of claim 1, wherein the first AI model and the second AI model are different generative AI models.

4. The computer-implemented method of claim 1, wherein determining the degree of compliance includes:
determining a complexity level of the one or more candidate images to construct a physical model depicting the one or more candidate images, using the set of tangible molding products, wherein the predefined threshold includes a predefined target skill level.

5. The computer-implemented method of claim 4, wherein determining the degree of compliance of the one or more candidate images with the set of predetermined content restrictions includes determining one or more of:
(1) whether the one or more candidate images depict subjects made of the same material as the set of tangible molding products,
(2) whether the one or more candidate images incorporate all selected colors of a set of selected colors defined in a particular combination of clay model features,
(3) whether a degree of complexity of the particular clay-based model of the one or more candidate images aligns with a target skill level defined in the particular combination of clay model features,
(4) whether the one or more candidate images align with a set of age-based content guidelines defined in the particular combination of clay model features, or
(5) whether a size of the particular clay-based model of the one or more candidate images is compatible with a quantity of the set of tangible molding products, wherein the quantity is defined in the particular combination of clay model features.

6. The computer-implemented method of claim 1, wherein the clay model features includes at least one of:
color,
subject,
theme, or
user-requested categories.

7. The computer-implemented method of claim 1,
wherein the first AI model receives a set of query context that directs the first AI model to generate images realizable using the set of tangible molding products, and
wherein the set of tangible molding products is queried from a database communicatively connected to the image generator application.

8. A computer-implemented method for upscaling digital representations of physical modeling creations using generative artificial intelligence (AI), comprising:
receiving, via a user interface of an image generator application, (1) an image depicting a tangible clay-based model associated with a plurality of clay model features and (2) a selection of clay model features;
causing a first AI model to generate one or more candidate digital representations depicting the tangible clay-based model based on the selection of clay model features,
wherein clay model features of the one or more candidate digital representations satisfy the selection of clay model features;
determining, using a second AI model, a degree of compliance of the one or more candidate digital representations with a set of predetermined content restrictions corresponding to a set of tangible molding products used to construct the tangible clay-based model; and
responsive to the degree of compliance satisfying a predefined threshold, presenting the one or more candidate digital representations on the user interface of the image generator application.

9. The computer-implemented method of claim 8, further comprising: generating a three-dimensional (3D) model of at least one of the one or more candidate digital representations in a format compatible with 3D printing.

10. The computer-implemented method of claim 8, further comprising:
generating, using a third AI model, a set of story elements for at least one of the one or more candidate digital representations based on the selection of clay model features; and
presenting the set of story elements proximate to the one or more candidate digital representations on the user interface.

11. The computer-implemented method of claim 8, wherein the first AI model is configured to generate the one or more candidate digital representations based on one or more of:
a pattern of the tangible clay-based model,
a shape of the tangible clay-based model,
a texture of the tangible clay-based model, or
a color of the tangible clay-based model.

12. The computer-implemented method of claim 8, wherein the first AI model and the second AI model are the same generative AI model.

13. The computer-implemented method of claim 8, wherein the first AI model and the second AI model are different generative AI models.

14. The computer-implemented method of claim 8, wherein the selection of clay model features includes at least one of:
color,
subject,
theme, or
user-requested categories.

15. A system for generating digital representations of physical modeling creations using generative artificial intelligence (AI), comprising:
an image repository associated with an image generator application including images depicting clay-based models structured based on a plurality of clay model features;
an interface of the image generator application configured to obtain a set of requests to generate images depicting new clay-based models, wherein each request specifies a different combination of clay model features;
an image generation engine of the image generator application configured to, for each request, cause a first AI model to generate one or more candidate images depicting a particular clay-based model based on a corresponding combination of clay model features of the request,
wherein clay model features of the one or more candidate images satisfy the corresponding combination of clay model features; and
a validation engine of the image generator application configured to, for each request, determine, using a second AI model, a degree of compliance of the one or more candidate images with a set of predetermined content restrictions corresponding to a set of tangible molding products used to construct the particular clay-based model,
wherein, responsive to the degree of compliance satisfying a predefined threshold, the image generator application is configured to populate the image repository with the one or more candidate images based on the clay model features of the one or more candidate images.

16. The system of claim 15,
wherein the image generator application is implemented in a product display having a touch screen interface, and
wherein the product display includes a set of tangible molding materials.

17. The system of claim 15, wherein the image generator application is further configured to:
cause a third AI model to generate a set of instructions to construct a physical model depicting the one or more candidate images using the set of tangible molding products, wherein generating the set of instructions includes:
determining a sequence of modeling steps associated with constructing the physical model in accordance with the corresponding combination of clay model features, and
generating a set of textual descriptions for each modeling step.

18. The system of claim 15, wherein the one or more candidate images is a first set of candidate images, wherein the image generator application is further configured to:
detect that the degree of compliance fails to satisfy the predefined threshold; and
cause the image generation engine to generate, using the first AI model, a second set of candidate images for each request, depicting a new clay-based model based on the corresponding combination of clay model features,
wherein the second set of candidate images is different from the first set of candidate images.

19. The system of claim 18, wherein the validation engine is further configured to:
determine, using the second AI model, a degree of compliance of the second set of candidate images with the set of predetermined content restrictions corresponding to the set of tangible molding products used to construct the new clay-based model.

20. The system of claim 15, wherein the image generator application is further configured to:
present the one or more candidate images on the interface of the image generator application;
receive, via the interface of the image generator application, interaction data indicating user approval of the one or more candidate images; and
responsive to receiving the interaction data, populate the image repository with the one or more candidate images based on the clay model features of the one or more candidate images.
